(19) United States
(12) Patent Application Publication
(10) Pub. No.: US 2012/0315547 A1
(43) Pub. Date: Dec. 13, 2012

(54) SOLID ELECTROLYTE COMPOSITION, SOLID ELECTROLYTE, LITHIUM ION SECONDARY BATTERY, AND METHOD FOR PRODUCING LITHIUM ION SECONDARY BATTERY

(75) Inventors: Takahito Itoh, Tsu-shi (JP); Takahiro Uno, Tsu-shi (JP); Yasuo Takeda, Tsu-shi (JP); Nobuyuki Imanishi, Tsu-shi (JP); Akira Itsubo, Tsu-shi (JP); Eiichi Nomura, Tsu-shi (JP); Shigemitsu Katoh, Tsu-shi (JP); Kiyotsugu Okuda, Tsu-shi (JP)

(73) Assignee: MIE UNIVERSITY, TSU-SHI (JP)

(21) Appl. No.: 13/578,422

(22) PCT Filed: Feb. 9, 2011
(86) PCT No.: PCT/JP2011/052694

§ 371 Date: Aug. 10, 2012

(30) Foreign Application Priority Data
Feb. 10, 2010 (JP) 2010-027447
Feb. 15, 2010 (JP) 2010-029640

(51) Int. Cl. H01M 10/0565

(52) U.S. Cl. 429/312

(57) ABSTRACT

This invention relates to a matrix of a solid electrolyte having a microstructure in which a non-reactive polyalkylene glycol is held on a co-crosslinked product produced by chemically co-crosslinking a hyperbranched polymer with a crosslinkable ethylene oxide multicomponent copolymer, such that a lithium salt is dissolved in the matrix. A negative electrode active material layer is a layer obtained by dispersing a negative electrode active material and a conduction aid in a lithium-ion conducting solid electrolyte. A positive electrode active material layer is a layer obtained by dispersing a positive electrode active material and a conduction aid in a lithium-ion conducting solid electrolyte.

### TECHNICAL FIELD

The present invention relates to a solid electrolyte composition and a solid electrolyte which have lithium ion conductivity, a lithium-ion secondary battery and a method for producing a lithium-ion secondary battery.

### BACKGROUND ART

A solid electrolyte prepared by dissolving a lithium salt in linear polyethylene oxide has a problem that lithium ion conductivity is decreased at low temperatures. It is thought that the decrease in the ionic conductivity is because mobility of a molecular chain is deteriorated at low temperatures because of high crystallinity of the linear polyethylene oxide.

In order to solve this problem, Patent Documents 1 and 2 propose a co-crosslinked product of a hyperbranched polymer having branched molecular chains including a polyalkylene oxide chain and a spacer as an alternative matrix to the linear polyethylene oxide and a solid electrolyte having a lithium salt dissolved in the co-crosslinked product. In the co-crosslinked product proposed by Patent Documents 1 and 2, the mobility of the molecular chain is higher than that of the linear polyethylene oxide, and the solid electrolyte proposed by Patent Documents 1 and 2 has higher lithium ion conductivity at low temperatures than that of the solid electrolyte prepared by dissolving a lithium salt in linear polyethylene oxide.

Patent Document 3 pertains to a lithium-ion secondary battery.

The lithium-ion secondary battery in Patent Document 3 has a structure in which a solid electrolyte layer (polymer electrolyte membrane) is interposed between a negative electrode active material layer (negative active material electrode) and a positive electrode active material layer (positive active material electrode).

The negative electrode active material layer is formed by irradiating a mixture of a negative electrode active material, a conduction aid, a lithium salt (supporting electrolyte salt), a precursor (polymerizable polymer) and so on with electron beams or the like (paragraph 0014).

The positive electrode active material layer is formed by irradiating a mixture of a positive electrode active material, a conduction aid, a lithium salt, a precursor and so on with electron beams or the like (paragraph 0013).

The solid electrolyte layer is formed by irradiating a mixture of a precursor and so on with electron beams or the like. Patent Document 1 describes that a network polymer containing ether oxygen (ether bond), in which a terminal group is a crosslinking group (polymerizable functional group), is used as a precursor (paragraph 0015).

Patent Document 3 presents a polymer, which is a copolymer of ethylene oxide and propylene oxide and has a terminal group of an acryloyl group, as a precursor (paragraph 0023).

### PRIOR ART DOCUMENTS

### Patent Documents

Patent Document 1: Japanese Patent Application Laid-Open No. 2006-344504
Patent Document 2: Japanese Patent Application Laid-Open No. 2008-130529
Patent Document 3: Japanese Patent Application Laid-Open No. 2003-92139

### SUMMARY OF INVENTION

### Problems to be Solved by the Invention

However, in the solid electrolytes proposed by Patent Documents 1 and 2, the lithium ion conductivity at low temperatures is still insufficient. Also, the solid electrolytes proposed by Patent Documents 1 and 2 have a problem that the strength is not sufficient.

The present invention was made in order to solve these problems, and an object of the present invention is to provide a solid electrolyte composition and a solid electrolyte which are excellent in the lithium ion conductivity at low temperatures and the strength.

Further, a lithium-ion secondary battery of Patent Document 3 has a problem that the charge-discharge performance is deteriorated at low temperatures and the strength of the solid electrolyte layer is not sufficient.

The present invention was made in order to solve these problems, and an object of the present invention is to provide a lithium-ion secondary battery with the improved charge-discharge performance at low temperatures and the improved strength of the solid electrolyte layer and a method for producing the lithium ion secondary battery.

### Means for Solving the Problems

A solid electrolyte composition of a first aspect of the present invention includes:

(a) a hyperbranched polymer having a branched molecular chain including a polyalkylene oxide chain and having a first crosslinking group;

(b) a crosslinkable ethylene oxide multicomponent copolymer which has a weight average molecular weight of 50000 to 300000 and is a multicomponent copolymer of two or more monomers including ethylene oxide and glycidyl ether having a second crosslinking group to react with the above-mentioned first crosslinking group;

(c) non-reactive polyalkylene glycol having molecular chains including an oligoalkylene glycol chain, in which all terminals of the molecular chains are blocked with a non-reactive terminal group; and

(d) a lithium salt.

A solid electrolyte composition of a second aspect of the present invention further includes:

(e) a noncrosslinkable ethylene oxide homopolymer which has a weight average molecular weight of 50000 to 300000 and does not have a group to react with the above-mentioned first crosslinking group,

in the solid electrolyte composition of the first aspect of the present invention.

A solid electrolyte composition of a third aspect of the present invention further includes:

(f) a noncrosslinkable ethylene oxide multicomponent copolymer which has a weight average molecular weight of 50000 to 300000, and is a multicomponent copolymer of two or more monomers including ethylene oxide and alkylene oxide other than ethylene-oxide, and does not have a group to react with the above-mentioned first crosslinking group,

in the solid electrolyte composition of the first aspect of the present invention.

A lithium-ion battery of a fourth aspect of the present invention includes a negative electrode active material layer, a positive electrode active material layer and a solid electrolyte layer. The negative electrode active material layer is a layer obtained by dispersing a negative electrode active material and a conduction aid in a lithium-ion conducting solid electrolyte. The positive electrode active material layer is a layer obtained by dispersing a positive electrode active material and a conduction aid in a lithium-ion conducting solid electrolyte. The solid electrolyte layer interposed between the negative electrode active material layer and the positive electrode active material layer is composed of a lithium-ion conducting solid electrolyte.

The lithium-ion conducting solid electrolyte is obtained by co-crosslinking the hyperbranched polymer with the crosslinkable ethylene oxide multicomponent copolymer in a precursor mixture containing:

(a) a hyperbranched polymer having a branched molecular chain including a polyalkylene oxide chain and having a first crosslinking group;

(b) a crosslinkable ethylene oxide multicomponent copolymer which has a weight average molecular weight of 50000 to 300000 and is a multicomponent copolymer of two or more monomers including ethylene oxide and glycidyl ether having a second crosslinking group to react with the above-mentioned first crosslinking group;

(c) non-reactive polyalkylene glycol having molecular chains including an oligoalkylene glycol chain, in which all terminals of the molecular chains are blocked with a non-reactive terminal group; and

(d) a lithium salt. The co-crosslinking is formed by a method by which chemical crosslinking can be formed, for example, electron beam crosslinking, UV (ultraviolet light) crosslinking and thermal crosslinking.

The present invention is also directed to a method for producing a solid electrolyte and a lithium-ion battery.

### Effects of the Invention

In accordance with the solid electrolyte composition of the first aspect of the present invention, since the solid electrolyte contains the hyperbranched polymer having high mobility of the molecular chain and non-reactive polyalkylene glycol having higher mobility of the molecular chain than the hyperbranched polymer, the lithium ion conductivity of the solid electrolyte is improved. Further, since the solid electrolyte contains an ethylene oxide multicomponent copolymer having high elasticity, the strength of the solid electrolyte is improved.

In accordance with the solid electrolyte composition of the second aspect of the present invention, since the noncrosslinkable ethylene oxide homopolymer is physically crosslinked, the strength of the solid electrolyte is further improved.

In accordance with the solid electrolyte composition of the third aspect of the present invention, since the noncrosslinkable ethylene oxide multicomponent copolymer is physically crosslinked, the strength of the solid electrolyte is further improved.

In accordance with the lithium-ion secondary battery of the fourth aspect of the present invention, the performance at low temperatures and the strength of the solid electrolyte layer of the lithium-ion secondary battery are improved.

The solid electrolyte and the method for producing a lithium-ion secondary battery of the present invention also exert a similar effect.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a sectional view of a lithium-ion secondary battery of an embodiment 1.

FIG. 2 is a sectional view of a negative electrode active material layer.

FIG. 3 is a sectional view of a positive electrode active material layer.

FIG. 4 is a schematic view of a matrix of a lithium-ion conducting solid electrolyte of the embodiment 1.

FIG. 5 is a flow chart illustrating a production procedure of the solid electrolyte of the embodiment 1.

FIG. 6 is a sectional view illustrating a method for producing a lithium-ion secondary battery of an embodiment 2.

FIG. 7 is a sectional view illustrating the method for producing a lithium-ion secondary battery of the embodiment 2.

FIG. 8 is a sectional view illustrating the method for producing a lithium-ion secondary battery of the embodiment 2.

FIG. 9 is a sectional view illustrating the method for producing a lithium-ion secondary battery of the embodiment 2.

FIG. 10 is a sectional view illustrating the method for producing a lithium-ion secondary battery of the embodiment 2.

FIG. 11 is a sectional view illustrating a method for producing a lithium-ion secondary battery of an embodiment 3.

FIG. 12 is a sectional view illustrating the method for producing a lithium-ion secondary battery of the embodiment 3.

FIG. 13 is a sectional view illustrating the method for producing a lithium-ion secondary battery of the embodiment 3.

FIG. 14 is a sectional view illustrating the method for producing a lithium-ion secondary battery of the embodiment 3.

FIG. 15 is a sectional view illustrating the method for producing a lithium-ion secondary battery of the embodiment 3.

FIG. 16 is a sectional view illustrating a production procedure of a lithium-ion secondary battery of an embodiment 4.

FIG. 17 is a sectional view illustrating the production procedure of a lithium-ion secondary battery of the embodiment 4.

FIG. 18 is a sectional view illustrating the production procedure of a lithium-ion secondary battery of the embodiment 4.

FIG. 19 is a sectional view illustrating the production procedure of a lithium-ion secondary battery of the embodiment 4.

FIG. 20 is a sectional view illustrating the production procedure of a lithium-ion secondary battery of the embodiment 4.

FIG. 21 is a sectional view illustrating the production procedure of a lithium-ion secondary battery of the embodiment 4.

FIG. 22 is a sectional view of a lithium-ion secondary battery of an embodiment 5.

FIG. 23 is a schematic view of a matrix of a lithium-ion conducting solid electrolyte of an embodiment 6.

FIG. 24 is a sectional view illustrating a production procedure of a lithium-ion secondary battery of an embodiment 7.

FIG. 25 is a sectional view illustrating the production procedure of a lithium-ion secondary battery of the embodiment 7.

FIG. 26 is a sectional view illustrating the production procedure of a lithium-ion secondary battery of the embodiment 7.

FIG. 27 is a sectional view illustrating the production procedure of a lithium-ion secondary battery of the embodiment 7.

FIG. 28 is a sectional view illustrating the production procedure of a lithium-ion secondary battery of the embodiment 7.

FIG. 29 is a sectional view illustrating the production procedure of a lithium-ion secondary battery of the embodiment 7.

FIG. 30 is a sectional view illustrating the production procedure of a lithium-ion secondary battery of the embodiment 7.

FIG. 31 is a sectional view illustrating the production procedure of a lithium-ion secondary battery of the embodiment 7.

FIG. 32 is a sectional view of the lithium-ion secondary battery of the embodiment 7.

### EMBODIMENT FOR CARRYING OUT THE INVENTION

### Embodiment 1

An embodiment 1 pertains to a monopolar lithium-ion secondary battery. The lithium-ion secondary battery of the embodiment 1 is a all-solid-state polymer lithium-ion secondary battery.

<Structure>

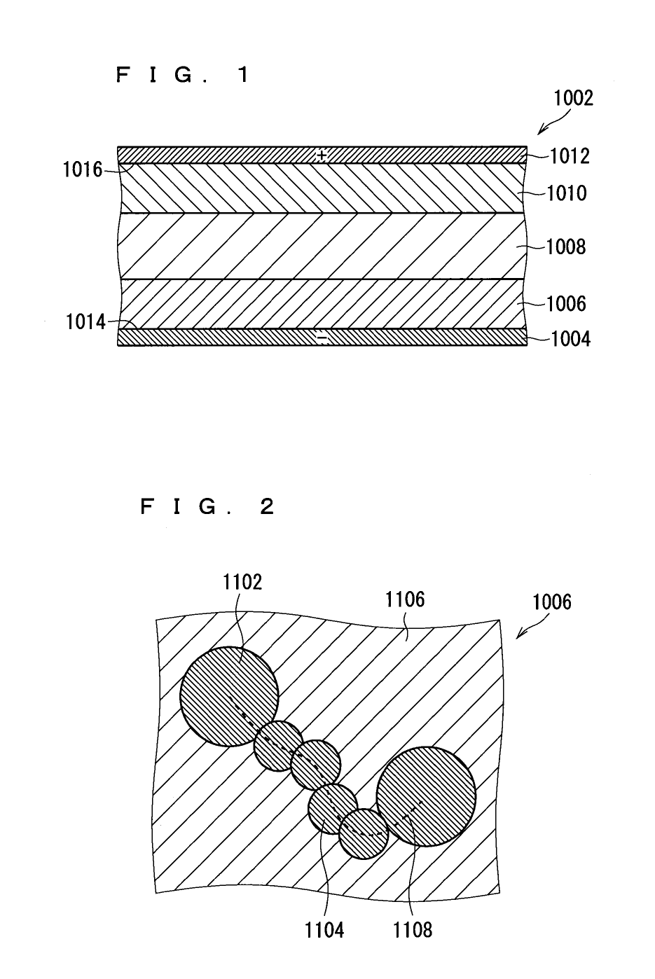

FIG. 1 is a schematic view of a lithium secondary battery of the embodiment 1. FIG. 1 shows a cross-section of a lithium-ion secondary battery 1002.

As shown in FIG. 1, the lithium-ion secondary battery 1002 has a structure in which a negative current collector 1004, a negative electrode active material layer 1006, a solid electrolyte layer 1008, a positive electrode active material layer 1010 and a positive current collector 1012 are laminated in this order. The solid electrolyte layer 1008 is interposed between the negative electrode active material layer 1006 and the positive electrode active material layer 1010, and the negative electrode active material layer 1006 and the positive electrode active material layer 1010 are in contact with the negative current collector 1004 and the positive current collector 1012, respectively.

The lithium-ion secondary battery 1002 does not require an expensive separator. Thereby, the lithium-ion secondary battery 1002 is simplified.

(Components Contained in Negative Electrode Active Material Layer 1006, Solid Electrolyte Layer 1008 and Positive Electrode Active Material Layer 1010)

The negative electrode active material layer 1006 contains a lithium-ion conducting solid electrolyte, a negative electrode active material and a conduction aid. The solid electrolyte layer 1008 is composed of a lithium-ion conducting solid electrolyte. The positive electrode active material layer 1010 contains a lithium-ion conducting solid electrolyte, a positive electrode active material and a conduction aid. All of or a part of the negative electrode active material layer 1006, the solid electrolyte layer 1008 and the positive electrode active material layer 1010 may contain a binder such as PVdF (polyvinylidene fluoride). Components other than these contained components may be contained when they do not interfere with resolution of the problem of improving the charge-discharge performance at low temperatures and the strength of the solid electrolyte layer.

Lithium-ion conducting solid electrolytes, which are components contained in the negative electrode active material layer 1006, the solid electrolyte layer 1008 and the positive electrode active material layer 1010, may be the same or may be different as long as they have features described below. The conduction aid of a component contained in the negative electrode active material layer 1006 and the conduction aid of a component contained in the positive electrode active material layer 1010 may be the same or may be different.

The negative electrode active material is a material which a lithium ion can be intercalated into/detached from at a lower potential than the positive electrode active material. The negative electrode active material is not particularly limited, but it is selected from among carbon, graphite, spinel compounds such as Li₄Ti₅O₁₂, Si, alloys of Si, Sn, alloys of Sn, and the like.

The positive electrode active material is a material which a lithium ion can be intercalated into/detached from. The positive electrode active material is not particularly limited, but it is selected from among bedded salt type compounds such as LiCoO₂, LiNiO₂, spinel compounds such as LiMn₂O₄, polyanion compounds such as LiFePO₄, LiMnₓFe₁₋ₓPO₄, and the like.

The conduction aid is powder or fiber of a conductive substance. The conduction aid is selected from conductive carbon powders such as carbon black, conductive carbon fibers such as carbon nanofiber, carbon nanotube, and the like. When a conductive carbon powder is called by a name derived from a production method, a starting material or the like, the conductive carbon powder is sometimes called “furnace black”, “channel black”, “acetylene black”, “thermal black” or the like.

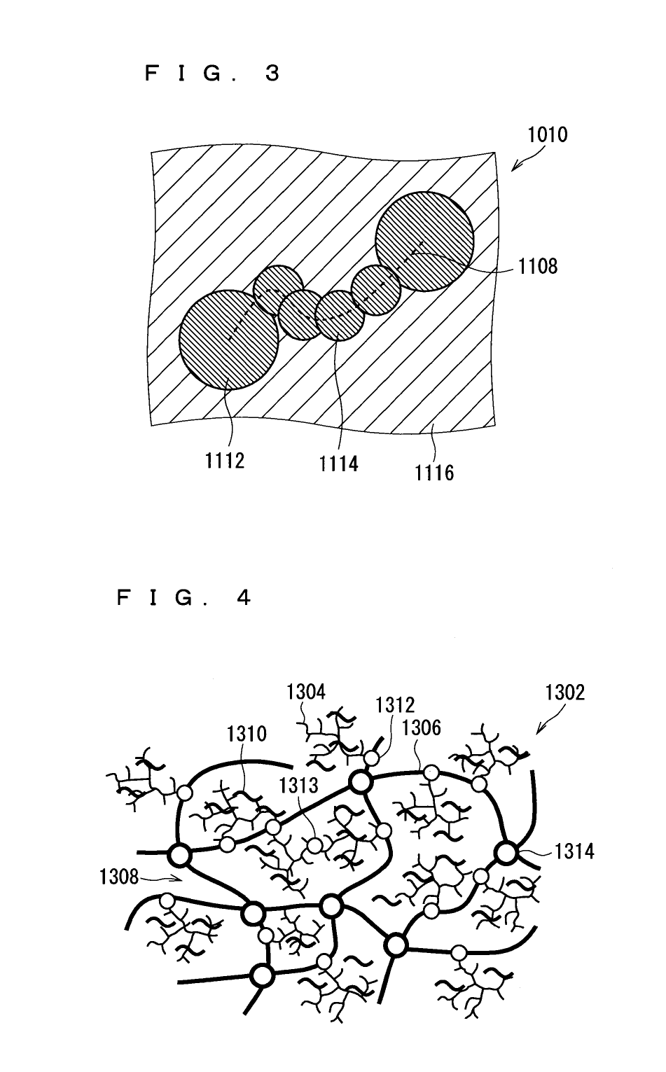

FIG. 2 and FIG. 3 are schematic views of a negative electrode active material layer 1006 and a positive electrode active material layer 1010, respectively. FIG. 2 and FIG. 3 show cross-sections of the negative electrode active material layer 1006 and the positive electrode active material layer 1010, respectively.

As shown in FIG. 2, in the negative electrode active material layer 1006, particles of a negative electrode active material 1102 and particles of a conduction aid 1104 are dispersed in a lithium-ion conducting solid electrolyte 1106. The particles of the negative electrode active material 1102 and the particles of the conduction aid 1104 are brought into contact with each other to link together to form a path 1118 for electron conduction within the negative electrode active material layer 1006. Thereby, the negative electrode active material layer 1006 has both of lithium ion conductivity and electron conductivity. The respective forms of the particles of the negative electrode active material 1102 and the particles of the conduction aid 1104 are not particularly limited and they may be powdery or may be fibrous.

Similarly, as shown in FIG. 3, in the positive electrode active material layer 1010, a positive electrode active material 1112 and a conduction aid 1114 are dispersed in a lithium-ion conducting solid electrolyte 1116. The particles of the positive electrode active material 1112 and particles of the conduction aid 1114 are brought into contact with each other to link together to form a path 1118 for electron conduction within the positive electrode active material layer 1010. Thereby, the positive electrode active material layer 1010 has both of lithium ion conductivity and electron conductivity. The respective forms of the particles of the positive electrode active material 1112 and the particles of the conduction aid 1114 are not particularly limited and they may be powdery or may be fibrous.

That the negative electrode active material layer 1006 and the positive electrode active material layer 1010 respectively have both of lithium ion conductivity and electron conductivity contributes to improvement of the charge-discharge performance of the lithium-ion secondary battery 1002.

(Negative Current Collector 1004 and Positive Current Collector 1012)

An electrical conductive material composing the current collector is not particularly limited, and metals such as aluminum, copper, titanium, nickel, iron, or alloys predominantly composed of these metals can be used. The electrical conductive material composing the negative current collector 1004 is not particularly limited, but it is desirably copper or an alloy predominantly composed of copper. The electrical conductive material composing the positive current collector 1012 is not particularly limited, but it is desirably aluminum or an alloy predominantly composed of aluminum. The respective forms of the negative current collector 1004 and the positive current collector 1012 are desirably the form of a foil, a plate or a exbanded mesh which has a current collecting surface 1014 in contact with the negative electrode active material layer 1006 and a current collecting surface 1016 in contact with the positive electrode active material layer 1010, and more desirably the form of a foil. The reason for this is that when the respective forms of the negative current collector 1004 and the positive current collector 1012 are the form of a foil, it becomes easy to bend the negative current collector 1004 and the positive current collector 1012, and the flexibility of the form of a lithium-ion secondary battery 1002 is improved, and the production of the lithium-ion secondary battery 1002 becomes easy.

(Lithium-Ion Conducting Solid Electrolyte)

FIG. 4 is a schematic view of a matrix of a lithium-ion conducting solid electrolyte contained in each of the negative electrode active material layer 1006, the solid electrolyte layer 1008 and the positive electrode active material layer 1010. FIG. 4 shows a microstructure of the matrix 1302. The lithium-ion conducting solid electrolyte is prepared by dissolving a lithium salt in the matrix 1302.

As shown in FIG. 4, the matrix 1302 has a microstructure in which non-reactive polyalkylene glycol 1310 is held on a co-crosslinked product 1308 produced by chemically co-crosslinking the hyperbranched polymer 1304 with the crosslinkable ethylene oxide multicomponent copolymer 1306. The co-crosslinked product 1308 has at least a crosslinking point 1312 where the hyperbranched polymer 1304 is chemically co-crosslinked with the crosslinkable ethylene oxide multicomponent copolymer 1306, but the co-crosslinked product 1308 may have a crosslinking point 1313 where the hyperbranched polymers 1304 are chemically co-crosslinked with each other, or may have a crosslinking point 1314 where the crosslinkable ethylene oxide multicomponent copolymers 1306 are chemically co-crosslinked with each other. The non-reactive polyalkylene glycol 1310 is principally held at a portion of the hyperbranched polymer 1304.

The lithium-ion conducting solid electrolyte is obtained by crosslinking the hyperbranched polymer 1304 with the crosslinkable ethylene oxide multicomponent copolymer 1306 in a precursor mixture containing the hyperbranched polymer 1304, the crosslinkable ethylene oxide multicomponent copolymer 1306, the non-reactive polyalkylene glycol 1310 and the lithium salt.

(Advantages Provided by Lithium-Ion Conducting Solid Electrolyte)

Since the solid electrolyte contains the hyperbranched polymer 1304 having high mobility of the molecular chain and non-reactive polyalkylene glycol 1310 having higher mobility of the molecular chain than the hyperbranched polymer 1304, the lithium ion conductivity of the solid electrolyte is improved and the performance at low temperatures of the lithium-ion secondary battery 1002 is improved. In the matrix 1302, a molecular chain of the crosslinkable ethylene oxide multicomponent copolymer 1306 is enough long, and therefore the mobility of the molecular chain of the hyperbranched polymer 1304 is hardly impaired and the lithium ion conductivity of the solid electrolyte is hardly decreased.

The hyperbranched polymer 1304 and the polyalkylene glycol 1310 also contribute to improvements of the tackiness of the negative electrode active material layer 1006, the solid electrolyte layer 1008 and the positive electrode active material layer 1010. Thereby, the adhesion of the negative electrode active material layer 1006, the solid electrolyte layer 1008 and the positive electrode active material layer 1010 is improved and therefore the production of the lithium-ion secondary battery 1002 becomes easy. Improvements in adhesion also contribute to reduction of electric resistance of an interface between layers and an improvement of charge-discharge performance of the lithium-ion secondary battery 1002.

Because the co-crosslinked product 1308 includes the crosslinkable ethylene oxide multicomponent copolymer 1306 having high elasticity and the crosslinkable ethylene oxide multicomponent copolymer 1306 having high elasticity becomes a spacer, the elasticity of the matrix 1302 is improved, the strength of the solid electrolyte is improved, and the strength of the lithium-ion secondary battery 1002 is improved.

The hyperbranched polymer 1304 which is liquid or viscous liquid at normal temperature hardly leaks from the matrix 1302 because it is co-crosslinked with the crosslinkable ethylene oxide multicomponent copolymer 1306, and thereby stability of the solid electrolyte is improved.

The non-reactive polyalkylene glycol 1310 which is a wax-like solid at normal temperature hardly leaks from the matrix 1302 because it is held at a portion of the hyperbranched polymer 1304, and thereby stability of the solid electrolyte is improved.

(Content)

The hyperbranched polymer 1304, the crosslinkable ethylene oxide multicomponent copolymer 1306 and the non-reactive polyalkylene glycol 1310 contain many ether oxygens. Thereby, it becomes possible that the ether oxygen solvates a lithium ion and a lithium salt is dissolved in the matrix 1302.

The weight percentage of the hyperbranched polymer 1304 in a total weight of the hyperbranched polymer 1304 and the non-reactive polyalkylene glycol 1310 is desirably 10 to 60% by weight, and more desirably 20 to 60% by weight. The reason for this is that when the percentage of the hyperbranched polymer 1304 is less than this range of a percentage, the tendency of reduction in strength of the solid electrolyte becomes marked. Further, the reason for this is that when the percentage of the hyperbranched polymer 1304 exceeds this range of a percentage, the tendency of reduction in lithium ion conductivity of the solid electrolyte becomes marked.

An amount of the crosslinkable ethylene oxide multicomponent copolymer 1306 is desirably 10 to 130 parts by weight and more desirably 20 to 80 parts by weight with respect to 100 parts by weight of a total of the hyperbranched polymer 1304 and the non-reactive polyalkylene glycol 1310. The reason for this is that when the amount of the crosslinkable ethylene oxide multicomponent copolymer 1306 is less than this range of an amount, the tendency of reduction in strength of the solid electrolyte becomes marked. Further, the reason for this is that when the amount of the crosslinkable ethylene oxide multicomponent copolymer 1306 exceeds this range of an amount, the tendency of reduction in lithium ion conductivity of the solid electrolyte becomes marked.

In addition, the solid electrolyte may contain elements other than the above-mentioned elements when they do not interfere with resolution of the problem of providing a solid electrolyte composition and a solid electrolyte which are excellent in the lithium ion conductivity at low temperatures and the strength.

A molar ratio ([Li]/[O]) of a molar quantity [Li] of the lithium ion to a molar quantity [O] of the ether oxygen contained in the matrix 1302 is desirably 1/5 to 1/25, more preferably 1/8 to 1/20, and particularly desirably 1/10 to 1/13. The reason for this is that when the molar ratio ([Li]/[O]) is within this range, a solid electrolyte having excellent lithium ion conductivity can be obtained.

(Hyperbranched Polymer 1304)

The hyperbranched polymer 1304 has a branched molecular chain including a polyalkylene oxide chain and has a crosslinking group which reacts with a crosslinking group of the crosslinkable ethylene oxide multicomponent copolymer 1306. The polyalkylene oxide chain means a molecular chain in which an alkylene group and ether oxygen are alternately arranged. A typical polyalkylene oxide chain is a polyethylene oxide chain. The polyalkylene oxide chain may have a substituent.

An average molecular weight of the hyperbranched polymer 1304 is desirably 2000 to 15000.

When the hyperbranched polymer 1304 has a crosslinking group which reacts with a crosslinking group of the crosslinkable ethylene oxide multicomponent copolymer 1306, a three-dimensional network co-crosslinked product 1308 of the hyperbranched polymer 1304 and the crosslinkable ethylene oxide multicomponent copolymer 1306 is formed.

The crosslinking group is selected from groups having an unsaturated bond such as an acryloyl group, a methacryloyl group, a vinyl group, and allyl group. Among these groups, the acryloyl group is desirably selected because the acryloyl group has excellent reactivity and does not interfere with the mobility of a lithium ion.

The terminal groups of the hyperbranched polymer 1304 are desirably a crosslinking group, but all of the terminal groups of the hyperbranched polymer 1304 do not have to be a crosslinking group, and a part of the terminal groups of the hyperbranched polymer 1304 may be a group such as an acetyl group which is not a crosslinking group. However, it is desirable that the terminal group of the hyperbranched polymer 1304 does not include a hydroxyl group. The reason for this is that when the terminal group includes the hydroxyl group, a lithium ion is trapped by the hydroxyl group and the tendency of reduction in lithium ion conductivity of the solid electrolyte is seen.

The hyperbranched polymer 1304 is desirably a polymer introducing a crosslinking group into a terminal group of the polymer obtained by reacting a hydroxyl group of a monomer represented by Chemical formula (1), in which two molecular chains having a terminal group of a hydroxyl group and including a polyalkylene oxide chain, and one molecular chain having a terminal group of A to react with a hydroxyl group respectively extend from X, with A of the monomer. The polyalkylene oxide chain may have a substituent.

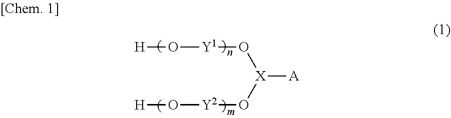

X in Chemical formula (1) is a trivalent group, Y¹ and Y² are an alkylene group, and m and n are an integer of 0 or more. However, when X does not contain a polyalkylene oxide chain, at least one of m and n is an integer of 1 or more.

A in Chemical formula (1) is desirably acid groups such as a carboxyl group, a sulfuric acid group, a sulfo group, a phosphoric acid group and the like, groups obtained by alkyl-esterifying these acid groups, groups obtained by chlorinating these acid groups, a glycidyl group, or the like, more desirably groups obtained by alkyl-esterifying these acid groups, and particularly desirably a group obtained by alkyl-esterifying a carboxyl group. The reason for this is that when A is a group obtained by alkyl-esterifying an acid group, a hydroxyl group can be easily reacted with A by an ester exchange reaction.

The ester exchange reaction is desirably performed in the presence of a catalyst such as organic tin compounds, for example, tributyltin chloride, triethyltin chloride and butyltin dichloride, or organic titanium compounds, for example, isopropyl titanate, desirably performed in a nitrogen flow, and desirably performed at a temperature of 100 to 250° C. However, the ester exchange reaction may be performed in another condition.

Introduction of the polyalkylene oxide chain is desirably carried out by adding the polyalkylene oxide chain to the hydroxyl group of the precursor in the presence of a basic catalyst such as potassium carbonate. However, the polyalkylene oxide chain may be introduced by another method.

X in Chemical formula (1) is desirably a group having three molecular chains which extend from Q and contain Z¹, Z² and Z³, represented by Chemical formula (2). Q in Chemical formula (2) is a methine group, an aromatic ring or an aliphatic ring, and Z¹, Z² and Z³ are an alkylene group or a polyalkylene oxide chain. The alkylene group or the polyalkylene oxide chain may have a substituent. All of or a part of Z¹, Z² and Z³ may be omitted.

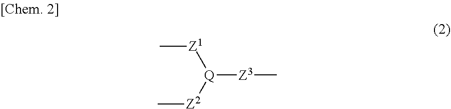

The hyperbranched polymer 1304 is more desirably a polymer obtained by introducing a crosslinking group into a terminal group of the polymer obtained by coupling a carbonyl group of a constituent unit represented by Chemical formula (3) with the polyalkylene oxide chain. m and n in Chemical formula (3) are desirably 1 to 20. This polymer is synthesized by polymerizing an ethylene oxide adduct of 3,5-dihydroxybenzoic acid or a derivative thereof (for example, methyl 3,5-dihydroxybenzoate), and introducing a crosslinking group as a terminal group.

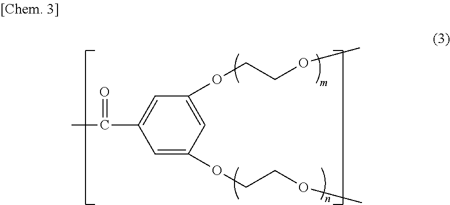

(Crosslinkable Ethylene Oxide Multicomponent Copolymer 1306)

A crosslinkable ethylene oxide multicomponent copolymer 1306 is a multicomponent copolymer of two or more monomers including ethylene oxide and glycidyl ether having a crosslinking group.

The crosslinkable ethylene oxide multicomponent copolymer 1306 is desirably a binary copolymer of ethylene oxide and glycidyl ether having a crosslinking group. The binary copolymer is a binary copolymer in which constituent units represented by chemical formulas (4) and (5) are arranged irregularly. R¹ in Chemical formula (5) is a crosslinking group, desirably an alkenyl group, and more desirably an allyl group.

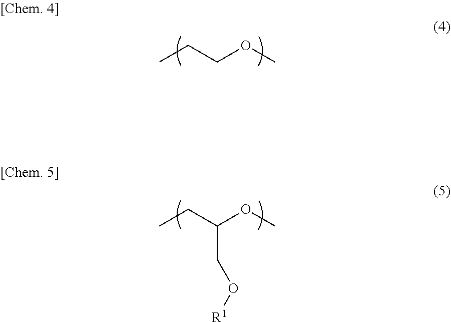

The crosslinkable ethylene oxide multicomponent copolymer 1306 may be a ternary copolymer of ethylene oxide, glycidyl ether having a crosslinking group and alkylene oxide other than ethylene oxide. The ternary copolymer is a ternary copolymer in which constituent units represented by chemical formulas (4) and (5) as well as a constituent unit represented by Chemical formula (6) are arranged irregularly. R² in Chemical formula (6) is an alkyl group having 1 to 2 carbon atoms.

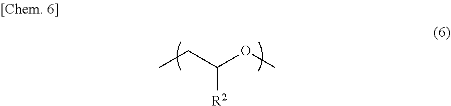

When the crosslinkable ethylene oxide multicomponent copolymer 1306 is the binary copolymer, a ratio of the constituent unit, which has a crosslinking group and is represented by Chemical formula (5), in a total of constituent units represented by chemical formulas (4) and (5) is desirably 20% or less, more desirably 0.2 to 10%, and particularly desirably 0.5 to 5%. When the crosslinkable ethylene oxide multicomponent copolymer 1306 is the ternary copolymer, a ratio of the constituent unit, which has a crosslinking group and is represented by Chemical formula (5), in a total of constituent units represented by chemical formulas (4), (5) and (6) is desirably 20% or less, more desirably 0.2 to 10%, and particularly desirably 0.5 to 5%. The reason for this is that when an amount of the constituent unit having a crosslinking group exceeds this range of a ratio, the tendency of reduction in lithium ion conductivity becomes marked. Further, the reason for this is that when an amount of the constituent unit having a crosslinking group is less than this range of a ratio, the tendency of reduction in strength of the solid electrolyte becomes marked.

A weight average molecular weight of the crosslinkable ethylene oxide multicomponent copolymer 1306 is desirably 50000 to 300000. Thereby, a portion which is easily elongated and contracted is produced in a three-dimensional network structure of a co-crosslinked product 1308, the elasticity of the solid electrolyte is improved, and the strength of the solid electrolyte is improved.

(Non-Reactive Polyalkylene Glycol 1310)

Both terminals of a molecular chain of the non-reactive polyalkylene glycol 1310 are blocked with a non-reactive terminal group. “Non-reactive” refers to a state in which a compound does not react with another element in the matrix 1302 and does not interfere with migration of lithium ions. Thereby, the crosslinking of the non-reactive polyalkylene glycol 1310 and hence the reduction in the mobility of the molecular chain of the non-reactive polyalkylene glycol 1310 is suppressed, and blocking of the lithium ion conduction by the non-reactive polyalkylene glycol 1310 is suppressed.

The non-reactive polyalkylene glycol 1310 is a homopolymer of ethylene oxide, a homopolymer of propylene oxide, a binary copolymer of ethylene oxide and propylene oxide, or the like and has a molecular chain including an oligoalkylene glycol chain.

A terminal group is selected from among an alkyl group, a cycloalkyl group, an alkyl ester group and the like having 1 to 7 carbon atoms.

The non-reactive polyalkylene glycol 1310 is desirably an oligomer represented by Chemical formula (7). n in Chemical formula (7) is desirably 4 to 45, and more desirably 5 to 25. A molecular weight of the non-reactive polyalkylene glycol 1310 is desirably 200 to 2000, and more desirably 300 to 1000.

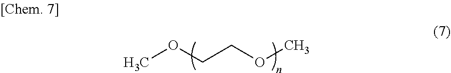

FIG. 4 shows a state in which a linear non-reactive polyalkylene glycol 1310 is held on a co-crosslinked product 1308, but an oligomer having a branched molecular chain including an oligoalkylene glycol chain may be held on the co-crosslinked product 1308 in place of the linear non-reactive polyalkylene glycol 1310. Surely, all terminals of the oligomer are blocked with non-reactive terminal groups.

(Lithium Salt)

Lithium salt is selected from among publicly known lithium salts such as LiPF₆, LiClO₄, LiBF₄, LiN(CF₃SO₂)₂, [LITFSI], LiN(CF₃CF₂SO₂)₂, LiCF₃SO₃. A lithium salt other than these lithium salts may be dissolved in a matrix.

(Production Procedure of Solid Electrolyte)

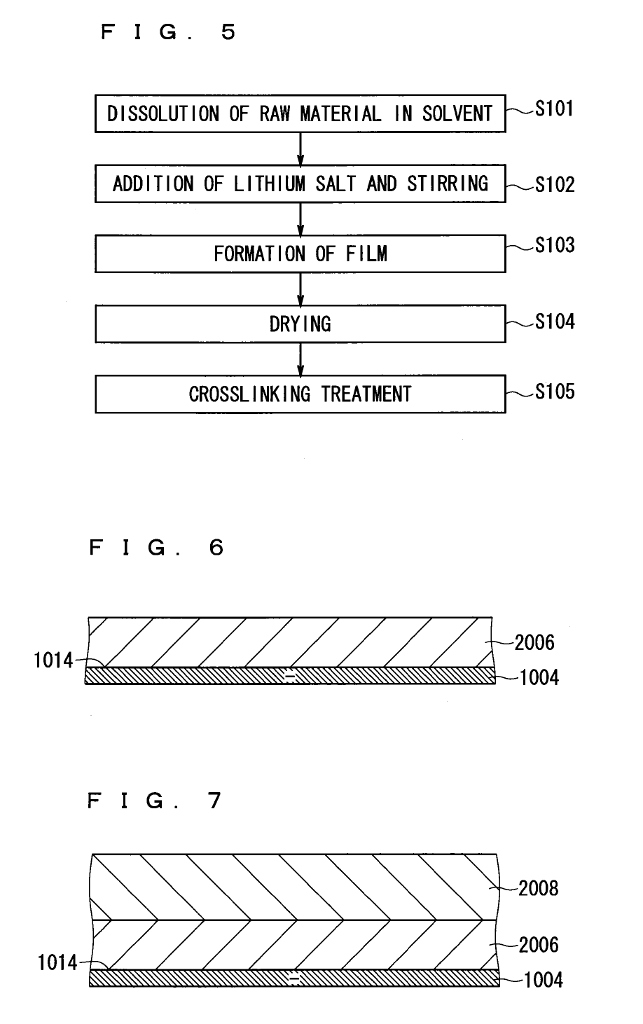

FIG. 5 is a flow chart illustrating a production procedure of the solid electrolyte of the embodiment 1.

In production of the solid electrolyte of the embodiment 1, first, a hyperbranched polymer 1304, a crosslinkable ethylene oxide multicomponent copolymer 1306 and non-reactive polyalkylene glycol 1310, which are raw materials of a matrix, are dissolved in a solvent such as acetonitrile, acetone, tetrahydrofrane, ethyl acetate (step S101).

Subsequently, a lithium salt is added to the solvent and stirred (step S102).

A viscous liquid thus obtained is applied onto a main surface of a base material such as a film and dried to form a film of a solid electrolyte composition which is a mixture composed of the hyperbranched polymer 1304, the crosslinkable ethylene oxide multicomponent copolymer 1306, the non-reactive polyalkylene glycol 1310 and the lithium salt (step S103).

After drying (step S104), the formed film of a solid electrolyte composition is subjected to a crosslinking treatment in which the hyperbranched polymer 1304 is crosslinked with the crosslinkable ethylene oxide multicomponent copolymer 1306 (step S105). Thereby, a lithium-ion conducting solid electrolyte is obtained. The crosslinking treatment is performed by electron beam crosslinking, thermal crosslinking, photo crosslinking, or the like, and the crosslinking treatment is desirably performed by electron beam crosslinking in which a crosslinking rate is fast and addition of an initiator is unnecessary.

### Embodiment 2

An embodiment 2 pertains to a method for producing a lithium-ion secondary battery applied to the production of the lithium-ion secondary battery of the embodiment 1.

(Outline)

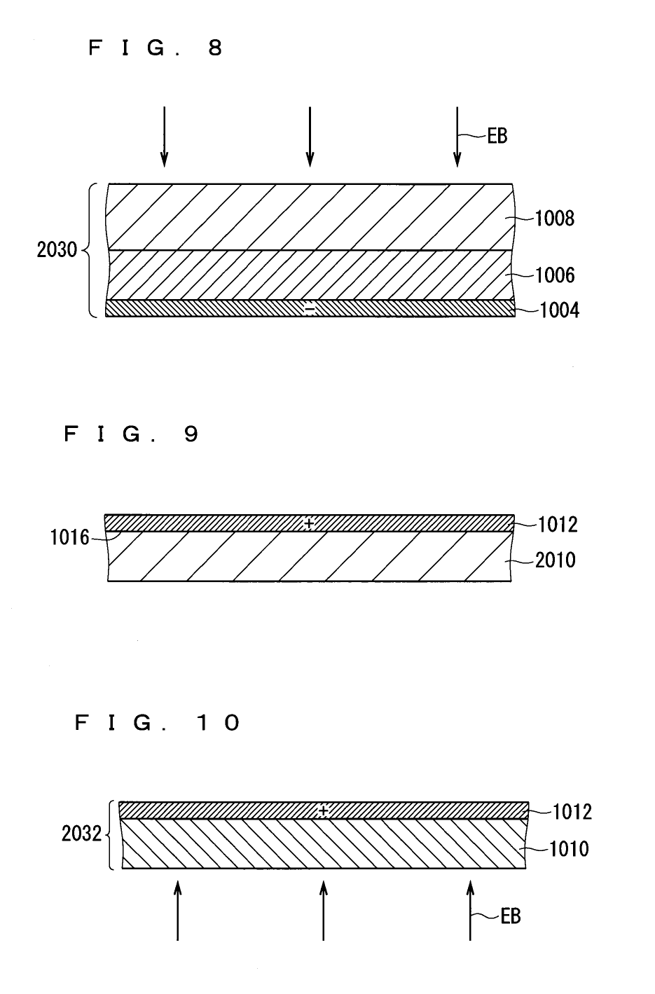

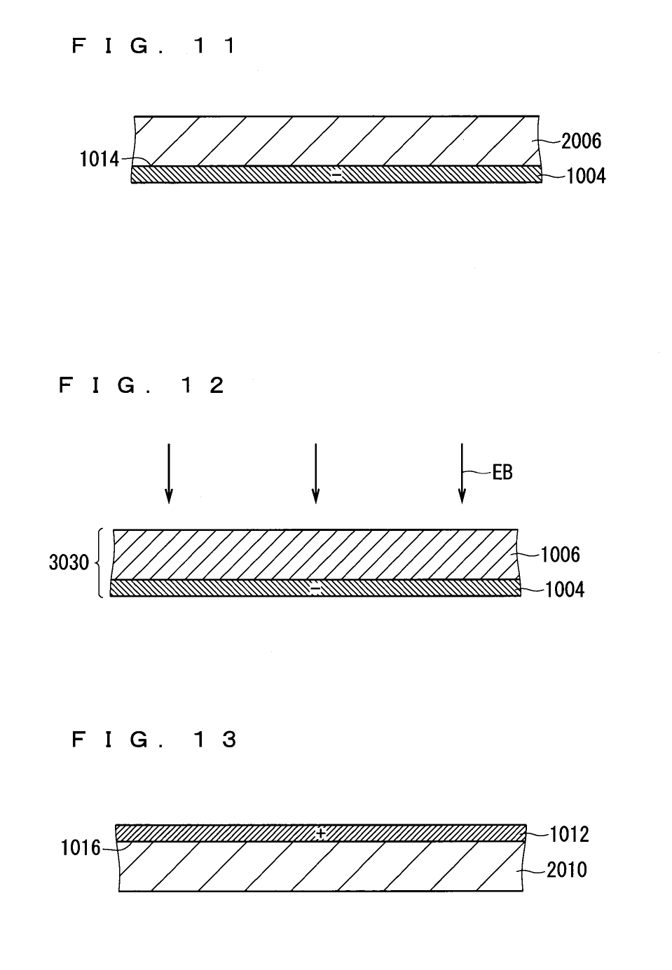

FIG. 6 to FIG. 10 are respectively a schematic view illustrating a method for producing a lithium-ion secondary battery of the embodiment 2. FIG. 6 to FIG. 10 respectively show a cross-section of a work-in-process of a lithium-ion secondary battery 1002. In the embodiment 2, a negative current collector 1004, a negative electrode active material layer 1006 and a solid electrolyte layer 1008 are laminated to produce a negative electrode-side laminate 2030 shown in FIG. 8, and a positive electrode active material layer 1010 and a positive current collector 1012 are laminated to produce a positive electrode-side laminate 2032 shown in FIG. 10. The negative electrode-side laminate 2030 is bonded to the positive electrode-side laminate 2032 to produce a lithium-ion secondary battery 1002.

(Preparation of Precursor Mixture)

A precursor mixture, which becomes a lithium-ion conducting solid electrolyte by irradiation of electron beams, is prepared prior to the preparation of the negative electrode-side laminate 2030 and the positive electrode-side laminate 2032. The precursor mixture is a mixture of the hyperbranched polymer, the crosslinkable ethylene oxide multicomponent copolymer, the non-reactive polyalkylene glycol and the lithium salt.

(Preparation of Negative Electrode-side Laminate 2030)

In the preparation of a negative electrode-side laminate 2030, as shown in FIG. 6, a precursor layer 2006 is formed on a current collecting surface 1014 of a negative current collector 1004. The precursor layer 2006 is a layer obtained by dispersing a negative electrode active material and a conduction aid in the precursor mixture, and is a layer which becomes a negative electrode active material layer 1006 by irradiation of electron beams. The precursor layer 2006 may be formed in any manner, and for example, it is formed by preparing an application liquid prepared by dispersing a precursor mixture, a negative electrode active material and a conduction aid in a dispersion medium such as acetonitrile, acetone, tetrahydrofrane, ethyl acetate or the like, applying the prepared application liquid onto a current collecting surface 1014, and drying the applied application liquid.

After the precursor layer 2006 is formed, as shown in FIG. 7, a precursor layer 2008 is formed on top of the precursor layer 2006. The precursor layer 2008 is a layer which is composed of the precursor mixture and becomes a solid electrolyte layer 1008 by irradiation of electron beams. The precursor layer 2008 may be formed in any manner, and for example, it is formed by preparing an application liquid prepared by dispersing a precursor mixture in a dispersion medium such as acetonitrile, acetone, tetrahydrofrane, ethyl acetate, applying the prepared application liquid onto the precursor layer 2006, and drying the applied application liquid. The application liquid is applied by a doctor blade method, a spin coating method, a screen printing method, a die coater method, a comma coater method, or the like, but when a roll-to-roll process described later is applied, the application liquid is suitably applied by a screen printing method, a die coater method, a comma coater method, or the like.

After the precursor layers 2006 and 2008 are formed, as shown in FIG. 8, the precursor layers 2006 and 2008 are irradiated with electron beams EB. Thereby, the precursor layer 2006 becomes a negative electrode active material layer 1006 and the precursor layer 2008 becomes a solid electrolyte layer 1008.

Irradiation of the electron beam EB is desirably performed in a nitrogen atmosphere. The reason for this is that when the precursor layer is irradiated with electron beams EB in the nitrogen atmosphere, an oxidation reaction is inhibited and production of a sub product which may deteriorate battery performance is suppressed.

The precursor layers 2006 and 2008 may be separately irradiated with electron beams EB without being simultaneously irradiated. That is, after irradiating the precursor layer 2006 with electron beams EB to modify the precursor layer 2006 to a negative electrode active material layer 1006, the precursor layer 2008 is formed over the negative electrode active material layer 1006 and irradiated with electron beams EB to modify the precursor layer 2008 to a solid electrolyte layer 1008. The precursor layer 2008 may be irradiated with electron beams EB from the side of a negative current collector 1004 instead of directly irradiating the precursor layer 2008.

(Production of Positive Electrode-side Laminate 2032)

In the production of a positive electrode-side laminate 2032, as shown in FIG. 9, a precursor layer 2010 is formed on a current collecting surface 1016 of a positive current collector 1012. The precursor layer 2010 is a layer obtained by dispersing a positive electrode active material and a conduction aid in the precursor mixture, and is a layer which becomes a positive electrode active material layer 1010 by irradiation of electron beams. The precursor layer 2010 may be formed in any manner, and for example, it is formed by preparing an application liquid prepared by dispersing a precursor mixture, a positive electrode active material and a conduction aid in a dispersion medium such as acetonitrile, acetone, tetrahydrofrane, ethyl acetate, applying the prepared application liquid onto a current collecting surface 1016, and drying the applied application liquid.

After the precursor layer 2010 is formed, as shown in FIG. 10, the precursor layer 2010 is irradiated with electron beams EB. Thereby, the precursor layer 2010 becomes a positive electrode active material layer 1010.

Irradiation of the electron beam EB is desirably performed in a nitrogen atmosphere. The precursor layer 2010 may be irradiated with electron beams EB from the side of a positive current collector 1012.

(Bonding Negative Electrode-Side Laminate 2030 to Positive Electrode-Side Laminate 2032)

After the negative electrode-side laminate 2030 and the positive electrode-side laminate 2032 are produced, the surface, at which the solid electrolyte layer 1008 is formed, of the negative electrode-side laminate 2030 is bonded to the surface, at which the positive electrode active material layer 1010 is formed, of the positive electrode-side laminate 2032. Thereby, a bonded body, in which the solid electrolyte layer 1008 is interposed between the negative electrode active material layer 1006 and the positive electrode active material layer 1010, is formed.

Thereafter, the bonded body undergoes, as required, a step of stacking the bonded body with an insulating plate interposed between the bonded bodies and a step of sealing the bonded body or a stacked body thereof to complete a lithium-ion secondary battery 1002.

The precursor layer may be irradiated with electron beams EB after bonding or at the same time as bonding instead of irradiating before bonding. In this case, the precursor layers 2006, 2008 and 2010 are simultaneously irradiated with electron beams EB.

More generally, a timing of irradiating with electron beams EB is optional, and the number of layers which are simultaneously irradiated with electron beams EB is also optional. An irradiation dose of the electron beam is also optional, but a desirable irradiation dose of the electron beam depends on a material or a film thickness. The irradiation dose is set through measurement of a gel fraction or evaluation of tackiness.

(Advantages of Crosslinking with Electron Beam EB)

Crosslinking with electron beams EB has an advantage that a crosslinking initiator which may deteriorate battery performance is unnecessary. Also, the crosslinking with electron beams EB has an advantage that it becomes possible to simultaneously crosslink two or more precursor layers by using the strength of transmitting power of the electron beam EB. Moreover, the crosslinking with electron beams EB has an advantage of improving productivity in comparison to crosslinking with heat or light.

(Application of Roll-to-Roll Process)

Application of the application liquid at the time of forming the precursor layers 2006, 2008 and 2010 may be performed by any method. However, it is desirable that a roll-to-roll process is applied to the production of the lithium-ion secondary battery 1002 and an application liquid is applied to a running web by a screen printing method, a die coater method or a comma coater method. Thereby, the productivity of the lithium-ion secondary battery 1002 is improved. Though the roll-to-roll process is applied to the production of the lithium-ion secondary battery 1002, the precursor layers 2006, 2008 and 2010, the negative electrode active material layer 1006, the solid electrolyte layer 1008 and the positive electrode active material layer 1010 are hardly damaged since these layers have enough flexibility.

### Embodiment 3

An embodiment 3 pertains to a method for producing a lithium-ion secondary battery employed in place of the method for producing a lithium-ion secondary battery of the embodiment 2.

FIG. 11 to FIG. 15 are respectively a schematic view illustrating a method for producing a lithium-ion secondary battery of the embodiment 3. FIG. 11 to FIG. 15 respectively show a cross-section of a work-in-process of a lithium-ion secondary battery 1002. The difference between the embodiment 2 and the embodiment 3 is that, in the embodiment 3, a solid electrolyte layer 1008 is formed in a positive electrode-side laminate 3002.

Particularly drawing attention to the difference between the embodiment 2 and the embodiment 3, the method for producing a lithium-ion secondary battery will be described.

After a precursor mixture is prepared, as shown in FIG. 11, a precursor layer 2006 is formed on a current collecting surface 1014 of a negative current collector 1004.

After the precursor layer 2006 is formed, as shown in FIG. 12, the precursor layer 2006 is irradiated with electron beams EB. Thereby, the precursor layer 2006 becomes a negative electrode active material layer 1006 to complete a negative electrode-side laminate 3030.

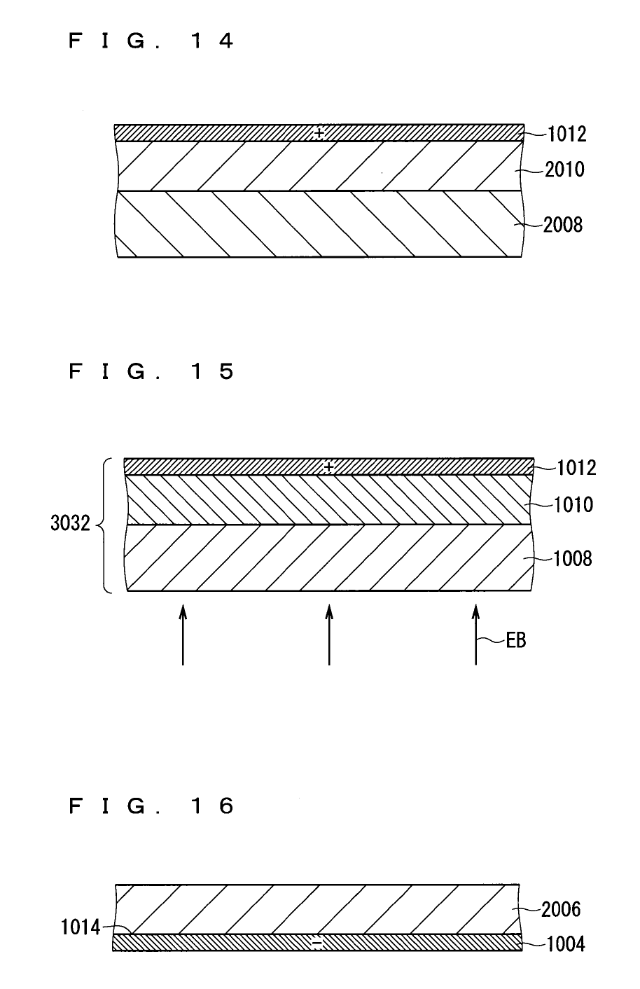

Aside from the preparation of the negative electrode-side laminate 3030, as shown in FIG. 13, a precursor layer 2010 is formed on a current collecting surface 1016 of a positive current collector 1012.

After the precursor layer 2010 is formed, as shown in FIG. 14, a precursor layer 2008 is formed on top of the precursor layer 2010.

After the precursor layers 2008 and 2010 are formed, as shown in FIG. 15, the precursor layers 2008 and 2010 are irradiated with electron beams EB. Thereby, the precursor layer 2008 becomes a solid electrolyte layer 1008 and the precursor layer 2010 becomes a positive electrode active material layer 1010 to complete a positive electrode-side laminate 3032. The precursor layers 2008 and 2010 may be separately irradiated with electron beams EB.

After the negative electrode-side laminate 3030 and the positive electrode-side laminate 3032 are produced, the surface, at which the negative electrode active material layer 1006 is formed, of the negative electrode-side laminate 3030 is bonded to the surface, at which the solid electrolyte layer 1008 is formed, of the positive electrode-side laminate 3032.

Also in the embodiment 3, a timing of irradiating with electron beams EB is optional, and the number of layers which are simultaneously irradiated with electron beams EB is also optional.

### Embodiment 4

An embodiment 4 pertains to a method for producing a lithium-ion secondary battery employed in place of the methods for producing a lithium-ion secondary battery of the embodiment 2 and the embodiment 3.

FIG. 16 to FIG. 21 are respectively a schematic view illustrating a method for producing a lithium-ion secondary battery of the embodiment 4. FIG. 16 to FIG. 21 respectively show a cross-section of a work-in-process of a lithium-ion secondary battery 1002. The difference between the embodiments 2, 3 and the embodiment 4 is that, in the embodiment 4, a solid electrolyte layer 1008 is prepared as another body separated from a negative electrode-side laminate 4030 and a positive electrode-side laminate 4032, and the negative electrode-side laminate 4030, the solid electrolyte layer 1008 and the positive electrode-side laminate 4032 are bonded to each other.

Particularly drawing attention to the difference between the embodiment 2 and the embodiment 4, the method for producing a lithium-ion secondary battery will be described.

After a precursor mixture is prepared, as shown in FIG. 16, a precursor layer 2006 is formed on a current collecting surface 1014 of a negative current collector 1004.

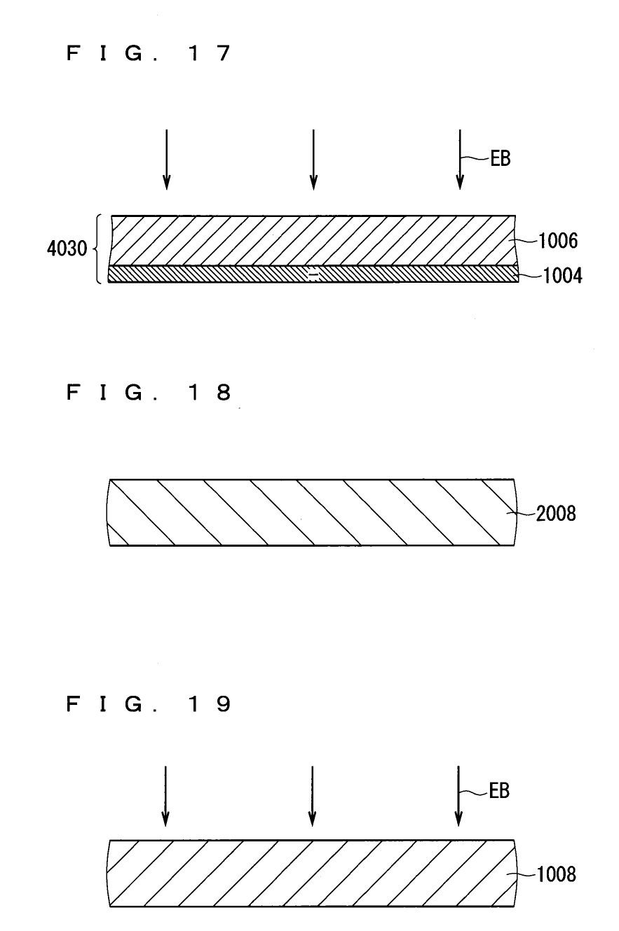

After the precursor layer 2006 is formed, as shown in FIG. 17, the precursor layer 2006 is irradiated with electron beams EB. Thereby, the precursor layer 2006 becomes a negative electrode active material layer 1006 to complete a negative electrode-side laminate 4030.

Aside from the preparation of the negative electrode-side laminate 4030, as shown in FIG. 18, a precursor layer 2008 is formed.

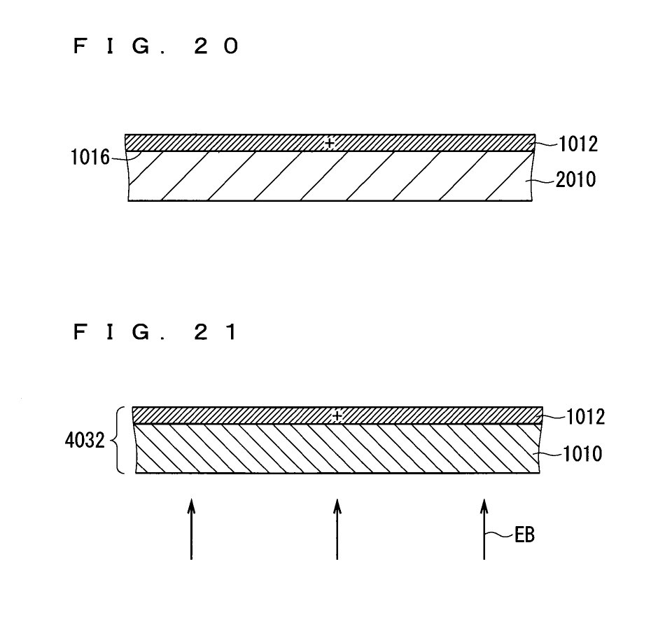

After the precursor layers 2008 is formed, as shown in FIG. 19, the precursor layers 2008 is irradiated with electron beams EB. Thereby, the precursor layer 2008 becomes a solid electrolyte layer 1008.

The precursor layer 2008 is formed, for example, by applying an application liquid to a sheet having a good peeling property, drying the applied application liquid, and peeling off the resulting applied film from the sheet. The applied film may be peeled off from the sheet before being irradiated with electron beams EB, or may be peeled off from the sheet after being irradiated with electron beams EB.

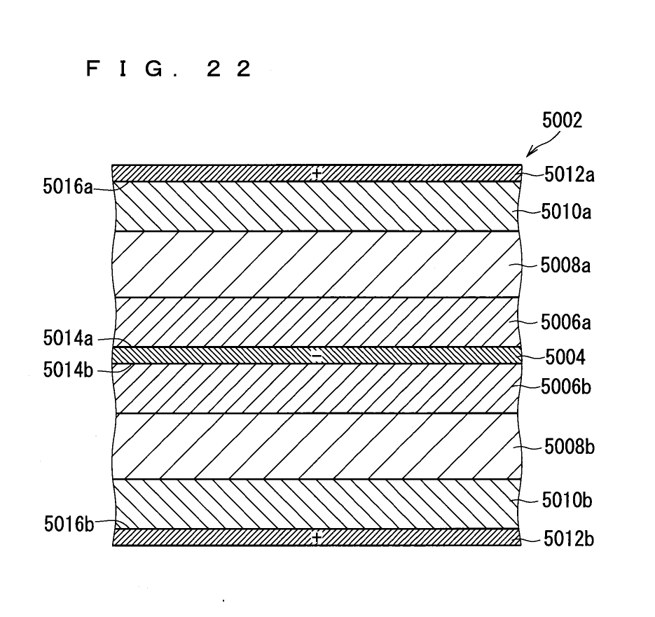

Aside from the preparation of the negative electrode-side laminate 4030 and the solid electrolyte layer 1008, as shown in FIG. 20, a precursor layer 2010 is formed on a current collecting surface 1016 of a positive current collector 1012.

After the precursor layer 2010 is formed, as shown in FIG. 21, the precursor layer 2010 is irradiated with electron beams EB. Thereby, the precursor layer 2010 becomes a positive electrode active material layer 1010 to complete a positive electrode-side laminate 4032.

After the negative electrode-side laminate 4030, the solid electrolyte layer 1008 and the positive electrode-side laminate 4032 are prepared, the surface, at which the negative electrode active material layer 1006 is formed, of the negative electrode-side laminate 3030 is bonded to one surface of the solid electrolyte layer 1008, and the other surface of the solid electrolyte layer 1008 is bonded to the surface, at which the solid electrolyte layer 1008 is formed, of the positive electrode-side laminate 3032. Thereby, a lithium-ion secondary battery 1002 shown in FIG. 1 is produced.

Also in the embodiment 4, a timing of irradiating with electron beams EB is optional, and the number of layers which are simultaneously irradiated with electron beams EB is also optional.

### Embodiment 5

An embodiment 5 pertains to a bipolar lithium-ion secondary battery. The lithium-ion secondary battery of the embodiment 5 is a all-solid-state polymer lithium-ion secondary battery.

FIG. 22 is a schematic view of the lithium-ion secondary battery of the embodiment 5. FIG. 22 shows a cross-section of a lithium-ion secondary battery 5002.

As shown in FIG. 22, the lithium-ion secondary battery 5002 has a structure in which a negative electrode active material layer 5006a, a solid electrolyte layer 5008a, a positive electrode active material layer 5010a and a positive current collector 5012a are laminated in this order on a first current collecting surface 5014a of a negative current collector 5004 and a negative electrode active material layer 5006b, a solid electrolyte layer 5008b, a positive electrode active material layer 5010b and a positive current collector 5012b are laminated in this order on a second current collecting surface 5014b of the negative current collector 5004. The lithium-ion secondary battery 5002 has a structure symmetrical with respect to the negative current collector 5004. Naturally, the lithium-ion secondary battery may have a bipolar structure which is symmetrical with respect to a positive current collector.

The lithium-ion secondary battery 5002 is produced in the same manner as in the embodiments 2 to 4 except that the negative electrode active material layers 5006a, 5006b, the solid electrolyte layers 5008a, 5008b, the positive electrode active material layers 5010a, 5010b and the positive current collectors 5012a, 5012b are formed on both sides of the negative current collector 5004.

### Embodiment 6

An embodiment 6 pertains to a lithium-ion conducting solid electrolyte employed in place of the lithium-ion conducting solid electrolyte of the embodiment 1.

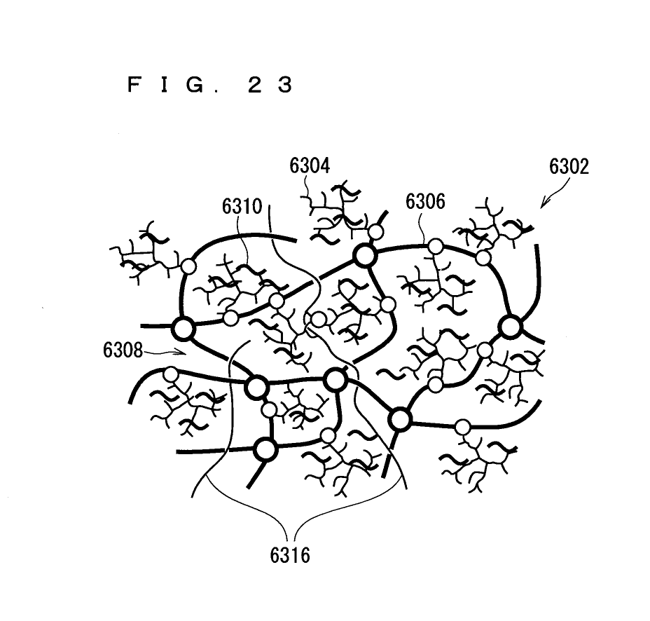

FIG. 23 is a schematic view of a matrix of a lithium-ion conducting solid electrolyte of the embodiment 6. FIG. 23 shows a microstructure of the matrix 6302.

As shown in FIG. 23, the matrix 6302 has a microstructure in which non-reactive polyalkylene glycol 6310 is held on a co-crosslinked product 6308 produced by chemically co-crosslinking the hyperbranched polymer 6304 with the crosslinkable ethylene oxide multicomponent copolymer 6306, as with the embodiment 1. Moreover, in the matrix 6302, noncrosslinkable ethylene oxide homopolymer 6316, which does not have a group to react with the crosslinking group of the hyperbranched polymer 6304, is physically crosslinked with the co-crosslinked product 6308. “Physical crosslinking” refers to entangle molecular chains with one another without forming chemical crosslinking based on a chemical bond. The strength of the solid electrolyte is further improved by the noncrosslinkable ethylene oxide homopolymer 6316.

The noncrosslinkable ethylene oxide homopolymer 6316 is a homopolymer in which a constituent unit represented by Chemical formula (8) is arranged.

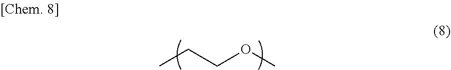

A weight average molecular weight of the noncrosslinkable ethylene oxide homopolymer 6316 is desirably 50000 to 300000.

A noncrosslinkable ethylene oxide multicomponent copolymer not having a crosslinking group to react with the crosslinking group of the hyperbranched polymer 6304 may be physically crosslinked with the co-crosslinked product 6308 in place of the noncrosslinkable ethylene oxide homopolymer 6316 or in addition to the noncrosslinkable ethylene oxide homopolymer 6316.

The noncrosslinkable ethylene oxide multicomponent copolymer is a multicomponent copolymer of two or more monomers including ethylene oxide and alkylene oxide (for example, alkylene oxide having 3 to 4 carbon atoms) other than ethylene oxide.

The noncrosslinkable ethylene oxide multicomponent copolymer is desirably a binary copolymer in which a constituent unit represented by Chemical formula (8) as well as a constituent unit represented by Chemical formula (9) are arranged irregularly. R¹ in Chemical formula (9) is an alkyl group having 1 to 2 carbon atoms and desirably a methyl group.

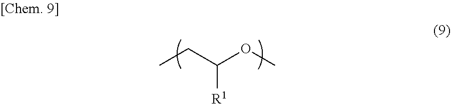

A weight average molecular weight of the noncrosslinkable ethylene oxide multicomponent copolymer is desirably 50000 to 300000.

Desirable contents of the hyperbranched polymer 6304, the non-reactive polyalkylene glycol 6310, the crosslinkable ethylene oxide multicomponent copolymer 6306 and a lithium salt are similar to those in the embodiment 1.

An amount of the noncrosslinkable ethylene oxide homopolymer 6316 or the noncrosslinkable ethylene oxide multicomponent copolymer is desirably 5 to 150 parts by weight and more desirably 10 to 100 parts by weight with respect to 100 parts by weight of a total of the hyperbranched polymer 6304, the non-reactive polyalkylene glycol 6310 and the crosslinkable ethylene oxide multicomponent copolymer 6306. The reason for this is that when the amount of the noncrosslinkable ethylene oxide homopolymer or the noncrosslinkable ethylene oxide multicomponent copolymer is less than this range of an amount, the effect of improving strength of the solid electrolyte is hardly seen. Further, the reason for this is that when the amount of the noncrosslinkable ethylene oxide homopolymer or the noncrosslinkable ethylene oxide multicomponent copolymer exceeds this range of an amount, the tendency of reduction in lithium ion conductivity of the solid electrolyte becomes marked.

The lithium-ion conducting solid electrolyte is obtained by crosslinking the hyperbranched polymer 6304 with the crosslinkable ethylene oxide multicomponent copolymer 6306 in a precursor mixture containing the hyperbranched polymer 6304, the crosslinkable ethylene oxide multicomponent copolymer 6306, the non-reactive polyalkylene glycol 6310, the noncrosslinkable ethylene oxide homopolymer 6316 (noncrosslinkable ethylene oxide multicomponent copolymer) and the lithium salt.

### Embodiment 7

FIG. 32 is a schematic view of a lithium-ion secondary battery of an embodiment 7. FIG. 32 shows a cross-section of a lithium-ion secondary battery 7002.

As shown in FIG. 32, the lithium-ion secondary battery 7002 has a structure in which a negative electrode active material layer 7006a, a solid electrolyte layer 7008a, a positive electrode active material layer 7010a and a positive current collector 7012a are laminated in this order on a first current collecting surface 7018a of a bipolar current collector 7018 and a positive electrode active material layer 7010b, a solid electrolyte layer 7008b, a negative electrode active material layer 7006b and a negative current collector 7004 are integrated in this order on a second current collecting surface 7018b of the bipolar current collector 7018. The lithium-ion secondary battery 7002 has a structure of laminating two cells in series. The lithium-ion secondary battery 7002 may have a structure of laminating three or more cells in series.

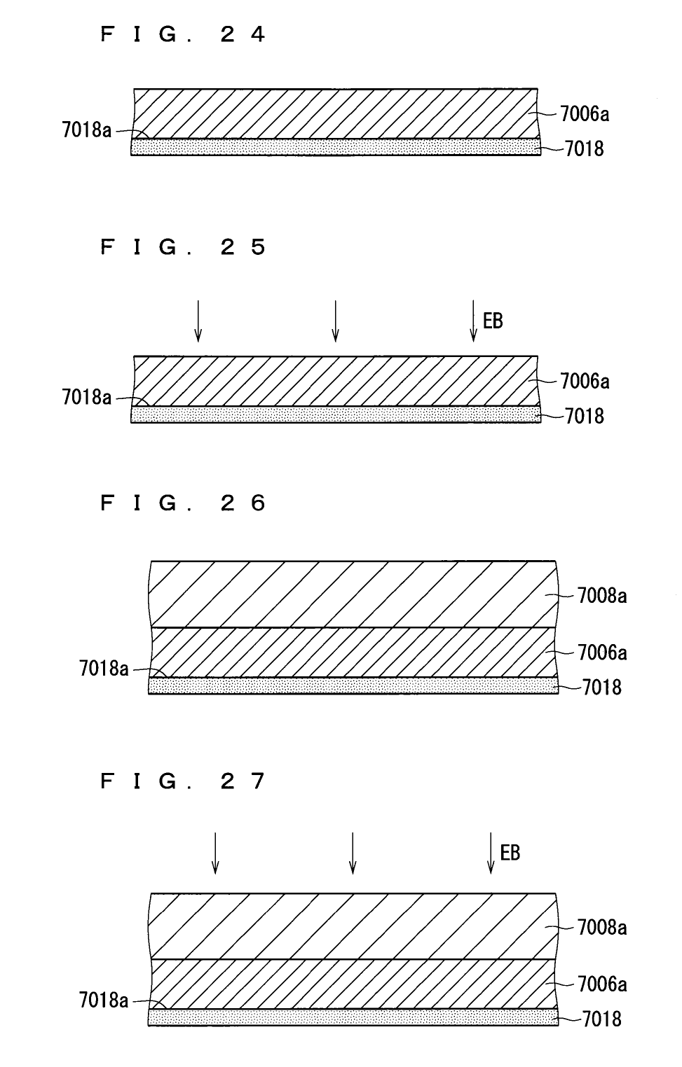

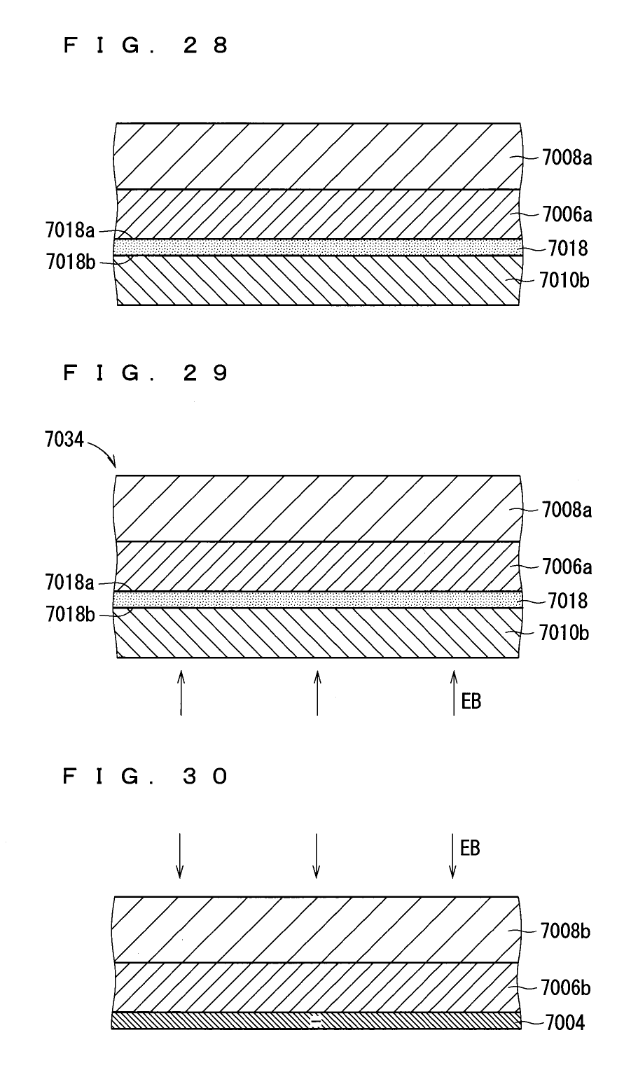

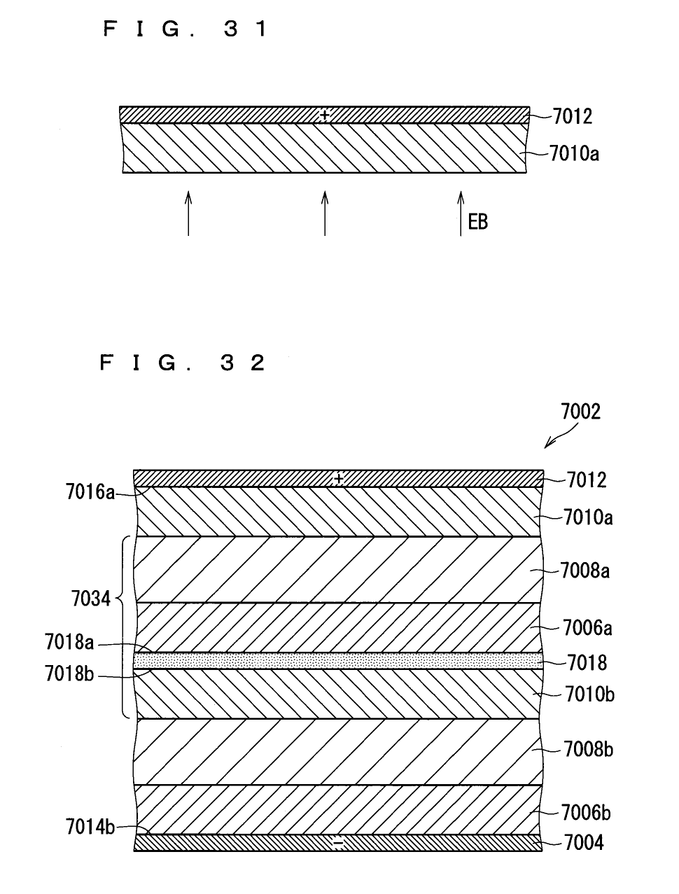

The method for producing the bipolar electrode laminate 7034 and the method for producing the lithium secondary battery 7002 are shown in FIG. 24 to FIG. 31, but the lithium-ion secondary battery 7002 is produced in the same manner as in the embodiments 2 to 4 except that the negative electrode active material layer 7006a, the positive electrode active material layer 7010b, the solid electrolyte layers 7008a and 7008b, the positive electrode active material layer 7010a, the negative electrode active material layer 7006b, the positive current collectors 7012 and the negative current collector 7004 are formed on both sides of the bipolar current collector 7018.

### Examples

<Synthesis of Hyperbranched Polymer>

Five g of an ethylene oxide 8 molar adduct of methyl 3,5-dihydroxybenzoate which is a monomer synthesized by adding an ethylene oxide chain to methyl 3,5-dihydroxybenzoate, and 0.05 g of tributyltin chloride as a catalyst were stirred with a magnetic stirrer. A temperature was set at 200° C. and stirring was performed in an atmosphere of a nitrogen flow.

Subsequently, the resulting product was purified to obtain 4.3 g of a hyperbranched polymer which is a yellow viscous liquid and has a hydroxyl group as a terminal group (hereinafter, referred to as a “hyperbranched polymer having a hydroxyl terminal group”). In accordance with gel permeation chromatography (hereinafter, referred to as “GPC”) measurement, an average molecular weight of the obtained hyperbranched polymer having a hydroxyl terminal group was 4000 on the standard polystyrene equivalent basis.

In purifying, a solution prepared by dissolving a reaction mixture in a small amount of tetrahydrofrane (hereinafter, referred to as “THF”) was precipitated in hexane and a precipitate was recovered by centrifugal separation. Subsequently, a solution prepared by dissolving the recovered precipitate in a small amount of THF was added dropwise to methanol to be precipitated, and a solvent was distilled off from a supernatant solution under a reduced pressure to obtain a viscous liquid. Moreover, subsequently, a solution prepared by dissolving the obtained viscous liquid in a small amount of THF was precipitated in diisopropyl ether and a low molecular oligomer was removed together with a supernatant solution. Finally, a remaining precipitate was dried under a reduced pressure.

Moreover, subsequently, a solution prepared by dissolving 2.1 ml triethylamine in 15 ml of methylene chloride was added dropwise to a mixture of 2.4 g of a hyperbranched polymer having a hydroxyl terminal group, 1.2 ml of acryloyl chloride and 10 ml of methylene chloride while stirring the mixture. A temperature was set at room temperature and stirring was performed for 24 hours.

Next, the resulting product was purified to obtain 2.2 g of a hyperbranched polymer (hereinafter, referred to as a “terminal-acrylated hyperbranched polymer”) which is a brown viscous liquid and has an acryloyl group as a terminal group. In accordance with GPC measurement, an average molecular weight of the obtained terminal-acrylated hyperbranched polymer was 3800 on the standard polystyrene equivalent basis.

In purifying, 1N hydrochloric acid and methylene chloride were added to a reaction mixture, the resulting mixture was fractioned by a separating funnel, and to the recovered methylene chloride phase, a saturated salt solution was added, the resulting mixture was fractioned again by a separating funnel to recover methylene chloride phase. Subsequently, anhydrous magnesium sulfate was added to the recovered methylene chloride phase to dry the recovered methylene chloride phase, and then magnesium sulfate was removed by filtration. Moreover, subsequently, methylene chloride was distilled off from the resulting filtrate under a reduced pressure to obtain a viscous liquid. The obtained viscous liquid was dissolved in a small amount of methylene chloride. Next, the resulting solution was precipitated in diisopropyl ether and a precipitate was recovered by centrifugal separation. Finally, a remaining precipitate was dried under a reduced pressure.

The terminal-acrylated hyperbranched polymer (Acryl-HBP (m=4)) thus synthesized was used below.

<Preparation of Solid Electrolyte>

In the preparation of a solid electrolyte, acetonitrile was added to a raw material of a solid electrolyte, which was weighed so as to have contents shown in Table 1 to Table 7, other than a lithium salt

“PEO (0.5)” and “PEO (0.3)” in a column “non-reactive polyalkylene glycol” in Table 1 to Table 7 respectively mean polyethylene glycols having a weight average molecular weight of 500 and a weight average molecular weight of 300.

“EO-AGE (62, 33/1)” and “EO-AGE (81, 53/1)” in a column “crosslinkable ethylene oxide multicomponent copolymer” in Table 1 to Table 7 respectively mean binary copolymers having a weight average molecular weight of 62000 and a weight average molecular weight of 81000, in which a ratio of ethylene oxide to allylglycidyl ether are 33:1 and 53:1.

“PEO (85)”, “PEO (110)” and “PEO (297)” in a column “noncrosslinkable ethylene oxide homopolymer/noncrosslinkable ethylene oxide multicomponent copolymer” in Table 1 to Table 7 respectively mean polyethylene oxide homopolymer having a weight average molecular weight of 85000, a weight average molecular weight of 110000 and a weight average molecular weight of 297000. “EO-PO (83, 13/1)” means a binary copolymer having a weight average molecular weight of 83000, in which a ratio of ethylene oxide to polypropylene oxide is 13:1.

Subsequently, LiN(SO₂CF₃)₂ weighed so as to have a molar ratio ([Li]/[O]) shown in Table 1 to Table 7 was added to a stirred mixture and the resulting mixture was stirred for 12 hours.

Moreover, subsequently, the resulting viscous solution was uniformly applied onto the surface of a polyimide film with a coater, and the film held at its end to avoid curling was irradiated with electron beams using an electron beam irradiation apparatus to perform a crosslinking treatment. An accelerating voltage of the electron beam was 200 kV, and an irradiation dose of the electron beam was a value shown in Table 1 to Table 7. The irradiation was performed at room temperature and in an atmosphere of a nitrogen flow.

Finally, the resulting film was dried to obtain a solid electrolyte film having a film thickness of 300 μm. Drying was carried out at 90° C. under a reduced pressure.

<Evaluation of Solid Electrolyte>

With respect to each of the prepared solid electrolytes 1 to 22, ionic conductivities at 80° C., 30° C. and 0° C., a glass transition temperature Tg, a melting point Tm, heat of fusion ΔHm, a 5% weight loss temperature Td5, 20% compressive elasticity modulus and a gel fraction were evaluated. The results of the evaluations are shown in Table 1 to Table 7.

Evaluation methods of the evaluation items are as follows.

Ionic conductivity: a sample to be measured obtained by punching out the solid electrolyte film with a punch having a diameter of 5 mm in an argon gas was placed in a HS cell manufactured by Hohsen Corporation, and a resistance value of the sample to be measured was measured with a complex impedance measuring apparatus, and a ionic conductivity was calculated from the measured resistance value. The cell in which the sample to be measured was placed for 8 hours or more in a constant-temperature oven set at 80° C. prior to measurement of the resistance value to adequately age the electrolyte and a stainless steel electrode. Measurement was carried out for every decrease of 10° C. in temperature from 80° C. which is a temperature of the constant-temperature oven in which the HS cell was placed. Measurement at each temperature was carried out after a lapse of 30 minutes since a temperature of the oven reached a predetermined temperature.

Glass transition temperature and melting point: These temperatures were measured by use of a differential scanning calorimeter (DSC). Measurement was performed at a temperature of −100 to 150° C. in an atmosphere of nitrogen flow. A temperature raising rate was 10° C./min.

5% weight loss temperature: 5% weight loss temperature was measured by using a simultaneous thermogravimetry/differential thermal analysis apparatus (TG/DTA). Measurement was performed at room temperature to 500° C. in an atmosphere of nitrogen flow. A temperature raising rate was 10° C./min.

20% compressive elasticity modulus: A compression test of a sample of 3 mm square was carried out by using a thermo-stress-strain measurement apparatus (TMA/SS).

Gel fraction: A weight W1 of a sample to be measured of 1 cm square was measured, and then the sample to be measured was immersed in 100 ml of acetonitrile and irradiated with an ultrasonic wave for 15 minutes. Subsequently, a portion insoluble in acetonitrile was recovered, the recovered portion was dried at 90° C. over 12 hours, and a weight W2 of the dried recovered portion was measured. A gel fraction (W2/W1×100) was calculated from the weights W1 and W2.

As shown in Table 1, a sample 1 was excellent in ionic conductivity, 20% compressive elasticity modulus, and gel fraction. Further, in the sample 1, a glass transition temperature Tg was observed but a melting point Tm was not observed. This means that the sample 1 is hardly crystallized and the lithium ion conductivity is hardly decreased even at low temperatures.

TABLE 1

| Sample No. | | 1 |
|---|---|---|
| Hyperbranched polymer | Acryl-HBP | 20 |
| Non-reactive polyalkylene glycol | PEO (0.5) | 80 |
| | PEO (0.3) | |
| Crosslinkable ethylene oxide | EO-AGE (62, 33/1) | 20 |
| multicomponent copolymer | EO-AGE (81, 53/1) | |
| Noncrosslinkable ethylene oxide | PEO (85) | |
| homopolymer/Noncrosslinkable ethylene | PEO (110) | |
| oxide multicomponent copolymer | PEO (297) | |
| | EO-PO (83, 13/1) | |
| [Li]/[0] | | 1/12 |
| Evaluation items | Irradiation dose (Mrad) | 12 |
| | Ionic conductivity at 80° C. (mS/cm) | 2.39 |
| | Ionic conductivity at 30° C. (mS/cm) | 0.28 |
| | Ionic conductivity at 0° C. (mS/cm) | 0.024 |
| | Glass transition temperature Tg (° C.) | −55.5 |
| | Melting point Tm (° C.) | — |
| | Heat of fusion ΔHm (J/g) | — |
| | 5% weight loss temperature Td5 (° C.) | 225 |
| | 20% compressive elasticity modulus (KPa) | 138 |
| | Gel fraction (%) | 18.3 |
| | Note | |

As shown in Table 2, a sample 2 not containing a hyperbranched polymer was liquid. Further, a sample 3 not containing a crosslinkable ethylene oxide multicomponent copolymer was gel-like and caused a non-reactive polyalkylene glycol to leak out from a matrix. A sample 4 not containing a non-reactive polyalkylene glycol was found to tend to be reduced in ionic conductivity.

TABLE 2

| Sample No. | | 2 | 3 | 4 |
|---|---|---|---|---|
| Hyperbranched polymer | Acryl-HBP | 0 | 20 | 20 |
| Non-reactive polyalkylene glycol | PEO (0.5) | 80 | 80 | 0 |
| | PEO (0.3) | | | |
| Crosslinkable ethylene oxide | EO-AGE(62, 33/1) | 20 | 0 | 20 |
| multicomponent copolymer | EO-AGE (81, 53/1) | | | |
| Noncrosslinkable ethylene oxide | PEO (85) | | | |
| homopolymer/Noncrosslinkable ethylene | PEO (110) | | | |
| oxide multicomponent copolymer | PEO (297) | | | |
| | EO-PO (83, 13/1) | | | |
| [Li]/[0] | | 1/12 | 1/12 | 1/12 |
| Evaluation items | Irradiation dose (Mrad) | 12 | 12 | 12 |
| | Ionic conductivity at 80° C. (mS/cm) | 2.52 | 1.70 | 0.23 |
| | Ionic conductivity at 30° C. (mS/cm) | 0.30 | 0.21 | 0.015 |
| | Ionic conductivity at 0° C. (mS/cm) | 0.027 | 0.018 | 0.0005 |
| | Glass transition temperature Tg (° C.) | −58.2 | −57.1 | −40.1 |
| | Melting point Tm (° C.) | 6.6 | — | — |
| | Heat of fusion ΔHm (J/g) | 0.19 | — | — |
| | 5% weight loss temperature Td5 (° C.) | 244 | 244 | 295 |
| | 20% compressive elasticity modulus (KPa) | | 160 | 3860 |
| | Gel fraction (%) | | | |
| | Note | liquid | gel-like | |

As shown in Table 3, a sample 5 in which non-reactive polyalkylene glycol was changed to PEO (0.3), and a sample 6 in which a crosslinkable ethylene oxide multicomponent copolymer was changed to EO-AGE (81, 53/1) respectively were excellent in ionic conductivity, 20% compressive elasticity modulus and gel fraction.

TABLE 3

| Sample No. | | 5 | 6 |
|---|---|---|---|
| Hyperbranched polymer | Acryl-HBP | 20 | 20 |
| Non-reactive polyalkylene glycol | PEO (0.5) | | 80 |
| | PEO (0.3) | 80 | |
| Crosslinkable ethylene oxide | EO-AGE (62, 33/1) | 20 | |
| multicomponent copolymer | EO-AGE (81, 53/1) | | 20 |
| Noncrosslinkable ethylene oxide | PEO (85) | | |
| homopolymer/Noncrosslinkable ethylene | PEO (110) | | |
| oxide multicomponent copolymer | PEO (297) | | |
| | EO-PO (83, 13/1) | | |
| [Li]/[0] | | 1/12 | 1/12 |
| Evaluation items | Irradiation dose (Mrad) | 11 | 12 |
| | Ionic conductivity at 80° C. (mS/cm) | 3.55 | 2.96 |
| | Ionic conductivity at 30° C. (mS/cm) | 0.554 | 0.355 |
| | Ionic conductivity at 0° C. (mS/cm) | 0.079 | 0.027 |
| | Glass transition temperature Tg (° C.) | −64 | −55.8 |
| | Melting point Tm (° C.) | — | — |
| | Heat effusion ΔHm (J/g) | — | — |
| | 5% weight loss temperature Td5 (° C.) | 201 | 277 |
| | 20% compressive elasticity modulus (KPa) | 153 | 129 |
| | Gel fraction (%) | 17.8 | 17.3 |
| | Note | | |

As shown in Table 4, when comparing the sample 1 and samples 7 to 9 which are different in the content of the hyperbranched polymer from one another, it is found that the ionic conductivity tends to decrease and the 20% compressive elasticity modulus tends to be improved as the content of the hyperbranched polymer increases.

TABLE 4

| Sample No. | | 1 | 7 | 8 | 9 |
|---|---|---|---|---|---|
| Hyperbranched polymer | Acryl-HBP | 20 | 60 | 100 | 150 |
| Non-reactive polyalkylene glycol | PEO (0.5) | 80 | 80 | 80 | 80 |
| | PEO (0.3) | 20 | 20 | 20 | 20 |
| Crosslinkable ethylene oxide | EO-AGE (62, 33/1) | | | | |
| multicomponent copolymer | EO-AGE (81, 53/1) | | | | |
| Noncrosslinkable ethylene oxide | PEO (85) | | | | |
| homopolymer/Noncrosslinkable ethylene | PEO (110) | | | | |
| oxide multicomponent copolymer | PEO (297) | | | | |
| | EO-PO (83, 13/1) | | | | |
| [Li]/[0] | | 1/12 | 1/12 | 1/12 | 1/12 |
| Evaluation items | Irradiation dose (Mrad) | 12 | 12 | 12 | 12 |
| | Ionic conductivity at 80° C. (mS/cm) | 2.39 | 0.91 | 0.44 | 0.20 |
| | Ionic conductivity at 30° C. (mS/cm) | 0.28 | 0.079 | 0.031 | 0.012 |
| | Ionic conductivity at 0° C. (mS/cm) | 0.024 | 0.005 | 0.002 | 0.0005 |
| | Glass transition temperature Tg (° C.) | −55.5 | −49.9 | −48.9 | −46.6 |
| | Melting point Tm (° C.) | — | — | — | — |
| | Heat of fusion ΔHm (J/g) | — | — | — | — |
| | 5% weight loss temperature Td5 (° C.) | 225 | 261 | 265 | 263 |
| | 20% compressive elasticity modulus (KPa) | 138 | 1790 | 2930 | 3840 |
| | Gel fraction (%) | 18.3 | | | |
| | Note | | | | |

As shown in Table 5, when comparing the sample 1 and samples 10 to 13 which are different in the content of the non-reactive polyalkylene glycol from one another, it is found that the ionic conductivity tends to be improved and the 20% compressive elasticity modulus tends to be decreased as the content of the non-reactive polyalkylene glycol increases.

TABLE 5

| Sample No. | | 1 | 10 | 11 | 12 | 13 |
|---|---|---|---|---|---|---|
| Hyperbranched polymer | Acryl-HBP | 20 | 20 | 20 | 20 | 20 |
| Non-reactive polyalkylene | PEO (0.5) | 80 | 20 | 60 | 100 | 160 |
| glycol | PEO (0.3) | | | | | |
| Crosslinkable ethylene oxide | EO-AGE (62, 33/1) | 20 | 20 | 20 | 20 | 20 |
| multicomponent copolymer | EO-AGE (81, 53/1) | | | | | |
| Noncrosslinkable | PEO (85) | | | | | |
| ethylene oxide | PEO (110) | | | | | |
| homopolymer/ | PEO (297) | | | | | |
| Noncrosslinkable | EO-PO (83, 13/1) | | | | | |
| ethylene oxide | | | | | | |
| multicomponent copolymer | | | | | | |
| [Li]/[0] | | 1/12 | 1/12 | 1/12 | 1/12 | 1/12 |
| Evaluation items | Irradiation dose | 12 | 12 | 12 | 12 | 12 |
| | (Mrad) | | | | | |
| | Ionic conductivity at | 2.39 | 0.90 | 1.60 | 1.76 | 2.47 |
| | 80° C. (mS/cm) | | | | | |
| | Ionic conductivity at | 0.28 | 0.070 | 0.17 | 0.21 | 0.31 |
| | 30° C. (mS/cm) | | | | | |
| | Ionic conductivity at | 0.024 | 0.003 | 0.014 | 0.017 | 0.025 |
| | 0° C. (mS/cm) | | | | | |
| | Glass transition | −55.5 | −46.0 | −55.7 | −56.4 | −57.5 |
| | temperature Tg (° C.) | | | | | |
| | Melting point Tm | — | — | — | — | — |
| | (° C.) | | | | | |
| | Heat of fusion ΔHm | — | — | — | — | — |
| | (J/g) | | | | | |
| | 5% weight loss | 225 | 267 | 239 | 248 | 256 |
| | temperature Td5 | | | | | |
| | (° C.) | | | | | |
| | 20% compressive | 138 | 2590 | 338 | 100 | |
| | elasticity modulus | | | | | |
| | (KPa) | | | | | |
| | Gel fraction (%) | 18.3 | | | | |
| | Note | | | | | |

As shown in Table 6, when comparing the sample 1 and samples 14 to 18 which are different in the content of the crosslinkable ethylene oxide multicomponent copolymer from one another, it is found that the ionic conductivity tends to be reduced and the 20% compressive elasticity modulus tends to be improved as the content of the crosslinkable ethylene oxide multicomponent copolymer increases.

TABLE 6

| Sample No. | | 1 | 14 | 15 | 16 | 17 | 18 |
|---|---|---|---|---|---|---|---|
| Hyperbranched polymer | Acryl-HBP | 20 | 20 | 20 | 20 | 20 | 20 |
| Non-reactive polyalkylene | PEO (0.5) | 80 | 80 | 80 | 80 | 80 | 80 |
| glycol | PEO (0.3) | | | | | | |
| Crosslinkable ethylene | EO-AGE (62, 33/1) | 20 | 40 | 60 | 80 | 100 | 130 |
| oxide multicomponent | EO-AGE (81, 53/1) | | | | | | |
| copolymer | | | | | | | |
| Noncrosslinkable | PEO (85) | | | | | | |
| ethylene oxide | PEO (110) | | | | | | |
| homopolymer/ | PEO (297) | | | | | | |
| Noncrosslinkable | EO-PO (83, 13/1) | | | | | | |
| ethylene oxide | | | | | | | |
| multicomponent copolymer | | | | | | | |
| [Li]/[0] | | 1/12 | 1/12 | 1/12 | 1/12 | 1/12 | 1/12 |
| Evaluation items | Irradiation dose | 12 | 12 | 12 | 12 | 12 | 12 |
| | (Mrad) | | | | | | |
| | Ionic conductivity at | 2.39 | 1.25 | 1.04 | 1.00 | 0.94 | 0.85 |
| | 80° C. (mS/cm) | | | | | | |
| | Ionic conductivity at | 0.28 | 0.121 | 0.095 | 0.087 | 0.077 | 0.074 |
| | 30° C. (mS/cm) | | | | | | |
| | Ionic conductivity at | 0.024 | 0.007 | 0.005 | 0.004 | 0.003 | 0.004 |
| | 0° C. (mS/cm) | | | | | | |
| | Glass transition | −55.5 | −51.5 | −51.5 | −49 | −48.9 | −47.5 |
| | temperature Tg (° C.) | | | | | | |
| | Melting point Tm | — | — | — | — | — | — |
| | (° C.) | | | | | | |
| | Heat of fusion ΔHm | — | — | — | — | — | — |
| | (J/g) | | | | | | |
| | 5% weight loss | 225 | 258 | 253 | 258 | 266 | 241 |
| | temperature Td5 | | | | | | |
| | (° C.) | | | | | | |
| | 20% compressive | 138 | 380 | 502 | 950 | 1250 | 1650 |
| | elasticity modulus | | | | | | |
| | (KPa) | | | | | | |
| | Gel fraction (%) | 18.3 | | | | | 38.3 |
| | Note | | | | | | |

As shown in Table 7, samples 19 to 22 containing a noncrosslinkable ethylene oxide homopolymer/noncrosslinkable ethylene oxide multicomponent copolymer were found to have a tendency of improving a gel fraction. However, when the content of the noncrosslinkable ethylene oxide homopolymer/noncrosslinkable ethylene oxide multicomponent copolymer is high, the ionic conductivity tends to decrease.

TABLE 7

| Sample No. | | 19 | 20 | 21 | 22 |
|---|---|---|---|---|---|
| Hyperbranched polymer | Acryl-HBP | 20 | 20 | 20 | 20 |
| Non-reactive polyalkylene glycol | PEO (0.5) | 80 | 80 | 80 | 80 |
| | PEO (0.3) | | | | |
| Crosslinkable ethylene oxide | EO-AGE (62, 33/1) | 20 | 20 | 20 | 20 |
| multicomponent copolymer | EO-AGE (81, 53/1) | | | | |
| Noncrosslinkable ethylene oxide | PEO (85) | 20 | 110 | | |
| homopolymer/Noncrosslinkable ethylene | PEO (110) | | | | |
| oxide multicomponent copolymer | PEO (297) | | | 73 | |
| | EO-PO (83, 13/1) | | | | 110 |
| [Li]/[0] | | 1/12 | 1/12 | 1/12 | 1/12 |
| Evaluation items | Irradiation dose (Mrad) | 12 | 12 | 12 | 12 |
| | Ionic conductivity at 80° C. (mS/cm) | 2.16 | 1.47 | 2.61 | 1.14 |
| | Ionic conductivity at 30° C. (mS/cm) | 0.221 | 0.095 | 0.3 | 0.119 |
| | Ionic conductivity at 0° C. (mS/cm) | 0.017 | 0.003 | 0.017 | 0.007 |
| | Glass transition temperature Tg (° C.) | −52.6 | −48.1 | −49.8 | −46.6 |
| | Melting point Tm (° C.) | — | 22.2 | 21.9 | — |
| | Heat of fusion ΔHm (J/g) | — | 2.6 | 1.3 | — |
| | 5% weight loss temperature Td5 (° C.) | 237 | 260 | 268 | 267 |
| | 20% compressive elasticity modulus (KPa) | | | | |
| | Gel fraction (%) | | 37.1 | 35.7 | 39.4 |
| | Note | | | | |

(Preparation of Solutions N1 to N6 of Precursor Mixture)

A hyperbranched polymer (Acryl-HBP (m=4)), a crosslinkable ethylene oxide binary copolymer (EO-AGE (81, 53/1), EO-AGE (62, 23/1)), a noncrosslinkable ethylene oxide polymer (L-8), non-reactive polyalkylene glycol (PEO500), a lithium salt (LiTFSI) and a solvent (AN) were mixed and stirred so as to have a weight ratio shown in Table 8. Thereby, solutions N1 to N6 of a precursor mixture were prepared. Further, viscosities of the solutions N1 to N6 of a precursor mixture were evaluated. The results of the evaluation are shown in Table 8.

TABLE 8
Composition (weight ratio) of Solution of Precursor Mixture

| Solution of precursor mixture | | N1 | N2 | N3 | N4* | N5 | N6 |
|---|---|---|---|---|---|---|---|
| Component contained | Acryl-HBP (m = 4) | 5 | 5 | 5 | 5 | 5 | 5 |
| | EO-AGE (81, 53/1) | 5 | | 5 | | 5 | 5 |
| | EO-AGE (62, 33/1) | | 5 | | | | |
| | L-8 | | | 2 | | 5 | 8 |
| | PE0500 | 20 | 20 | 20 | 20 | 20 | 20 |
| | LiTFSI | 15.74 | 15.74 | 16.83 | 12.34 | 15.77 | 20.08 |
| | AN | 60 | 60 | 60 | 60 | 60 | 60 |

| | | | | | | |
|---|---|---|---|---|---|---|
| Viscosity (cP) | 86.4 | 93.1 | 130.8 | 5.1 | 105.6 | 610.7 |

*Comparative Example

“EO-AGE (81, 53/1)” and “EO-AGE (62, 33/1)” are respectively binary copolymers having a number average molecular weight of 81000 and a number average molecular weight of 62000, in which a ratio of ethylene oxide to allyl glycidyl ether are 53:1 and 33:1. “L-8” is an ethylene oxide polymer (ALKOX (registered trademark) L-8) having a number average molecular weight of 85000 manufactured by Meisei Chemical Works, Ltd. (Kyoto-shi, Kyoto, JAPAN). “PEO500” is polyalkylene glycol having a number average molecular weight of 500. “AN” is acetonitrile. A weight ratio of LiTFSI was determined in such a way that a molar ratio [Li]/[O] is 1/12.

(Relationship Between Electron Beam Irradiation Dose and Gel Fraction/Tackiness)

A solution of a precursor mixture shown in Table 9 and Table 10 was applied onto a sheet of polytetrafluoroethylene. A thickness of the applied solution was 60 μm. Subsequently, the applied film was irradiated with electron beams with an irradiation dose shown in Table 9 and Table 10 to crosslink the hyperbranched polymer with the crosslinkable ethylene oxide binary copolymer. An accelerating voltage of the electron beam was 200 kV. The gel fraction and the tackiness of the applied film after being irradiated with electron beams were evaluated. The results of the evaluations are shown in Table 9 and Table 10.

TABLE 9
Gel Fraction (%)

| Solution of precursor mixture | | N1 | N2 | N3 | N4* | N5 | N6 |
|---|---|---|---|---|---|---|---|
| Irradiation dose | 30 | 8.9 | | 1.6 | 5.1 | 5.2 | 8.8 |
| (kGy) | 50 | 11 | | 19.5 | 8.2 | 4.1 | 22 |
| | 80 | 16.9 | | 28.6 | 16.9 | 18.2 | 33.2 |
| | 100 | 15.4 | | 20 | 12.2 | 17.1 | 29.2 |
| | 120 | 15.5 | 18.5 | | | | |

*Comparative Example

TABLE 10
Tackiness

| Solution of precursor mixture | | N1 | N2 | N3 | N4* | N5 | N6 |
|---|---|---|---|---|---|---|---|
| Irradiation dose | 30 | C | | C | C | C | C |
| (kGy) | 50 | B | | B | C | C | B |
| | 80 | A | | A | C | A | A |
| | 100 | A | | A | C | A | B |
| | 120 | A | A | | | | |

*Comparative Example

The gel fraction is a ratio of a dried weight of the applied film after immersing it in acetonitrile to a dried weight of the applied film before immersing it in acetonitrile. The gel fraction is a measure indicating the rate of progression of a crosslinking reaction.

The tackiness was classified into three levels of “C”, “B” and “A” by a finger touch method. The level “C” means that the layer has adhesion, but it adheres to a finger. The level “A” means that the layer has adhesion, and does not adhere to a finger. The level “B” means that the layer is an intermediate between “A” and “C”. In order to improve bonding strength and interface resistance, the layer has adhesion and does not adhere to a finger.

As shown in Table 9, a crosslinking reaction began to proceed when an irradiation dose substantially exceeds 50 kGy. The irradiation dose at which the crosslinking reaction most proceeds was generally 80 kGy.

As shown in Table 10, the irradiation dose at which the tackiness becomes best was generally 80 kGy. However, an applied film of the solution N4 of a precursor mixture not containing the crosslinkable ethylene oxide polymer did not have good tackiness even when crosslinking proceeded, and was brittle.

(Preparation of Inks G1 to G4 for Forming Negative Electrode Active Material Layer)

A negative electrode active material (CGB-10), a conduction aid (VGCF, Ketjen Black), a solution N1 of a precursor mixture, a noncrosslinkable ethylene oxide polymer (L-8, R-1000), a binder (PVdF) and a solvent (AN) were wet mixed so as to have weight ratios shown in Table 11. Mixing was carried out by use of a ball mill. Thereby, inks G1 to G4 for forming a negative electrode active material layer (hereinafter, referred to as an “ink for forming a negative electrode active material layer”) were prepared.

TABLE 11
Composition (weight ratio) of Inks for Forming
Negative Electrode Active Material Layer

| | | Ink for forming negative electrode | | | | |
|---|---|---|---|---|---|---|
| | | active material layer | | | | |
| | | G1 | G2 | G3 | G4 | T1 |
| Component | CGB-10 | 13.5 | 17 | 22.5 | 13.5 | |
| contained | Li₄Ti₅O₁₂ | | | | | 132.5 |
| | VGCF | 1.5 | 0.6 | 0.9 | 1 | |
| | Ketjen Black | 1.5 | | | | |
| | CVCF | | | | | 32.5 |
| | Solution N1 of | 13.5 | 9.8 | 15 | 13.5 | 162.5 |
| | precursor mixture | | | | | |
| | L-8 | 1.5 | 4.1 | | 1.5 | |
| | R-1000 | | | 6 | | 6.63 |
| | PVdF | | | | 1 | |
| | AN | 60 | 60 | 47.2 | 60 | 100 |

“CGB-10” is natural graphite manufactured by Nippon Graphite Industries, Co., Ltd. (Otsu-shi, Shiga, JAPAN). “VGCF (registered trademark)” is a carbon nanofiber manufactured by Showa Denko K.K. (Minato-ku, Tokyo, JAPAN). “Ketjen Black” is carbon black manufactured by Ketjenblack International Co. “R-1000” is an ethylene oxide polymer (ALKOX (registered trademark) R-1000) having a number average molecular weight of 300000 manufactured by Meisei Chemical Works, Ltd. (Kyoto-shi, Kyoto, JAPAN).

(Preparation of Ink T1 for Forming Negative Electrode Active Material Layer)

A negative electrode active material (Li₄Ti₅O₁₂) and a conduction aid (CVCF) were dry mixed so as to have weight ratios shown in Table 11. Mixing was carried out for 10 hours by use of a ball mill. Subsequently, the resulting mixture, a solution N1 of a precursor mixture, a noncrosslinkable ethylene oxide homopolymer (R-1000) and a solvent (AN) were wet mixed so as to have weight ratios shown in Table 11. Mixing was carried out for 10 hours by use of a ball mill. Thereby, an ink T1 for forming a negative electrode active material layer was prepared. “CVCF” is a conduction aid manufactured by Showa Denko K.K.

(Preparation of Inks T2 to T4 for Forming Negative Electrode Active Material)

A negative electrode active material (Li₄Ti₅O₁₂) and a conduction aid (VGCF) were dry mixed so as to have weight ratios shown in Table 12. Mixing was carried out for 10 hours by use of a ball mill. Subsequently, the resulting mixture, a solution N1 of a precursor mixture, a noncrosslinkable ethylene oxide homopolymer (R-1000) and a solvent (AN) were wet mixed so as to have weight ratios shown in Table 12. Mixing was carried out for 10 hours by use of a ball mill. Thereby, inks T2 to T4 for forming a negative electrode active material layer were prepared. “VGCF” is a conduction aid manufactured by Showa Denko K.K.

TABLE 12
Composition (weight ratio) of Inks for Forming
Negative Electrode Active Material Layer

| | | Inks for forming negative electrode | | |
|---|---|---|---|---|
| | | active material layer | | |
| | | T2 | T3 | T4 |
| Component | CGB-10 | | | |
| contained | Li₄Ti₅O₁₂ | 132.5 | 72 | 95 |
| | VGCF | 32.5 | 5.4 | 2.4 |
| | Ketjen Black | | | |
| | Solution N1 of | 162.5 | 18 | 5.5 |
| | precursor mixture | | | |
| | L-8 | | | |
| | R-1000 | 6.63 | 14.4 | 9 |
| | PVdF | | | |
| | AN | 100 | 80 | 80 |

(Preparation of Inks P1, P2 for Forming Positive Electrode Active Material Layer)

A positive electrode active material (LiFePO₄/C) and a conduction aid (SP-270) were dry mixed so as to have weight ratios shown in Table 13. Mixing was carried out for 10 hours by use of a ball mill. Subsequently, the resulting mixture, a solution N1 of a precursor mixture, a noncrosslinkable ethylene oxide polymer (L-11) and a solvent (AN) were wet mixed so as to have weight ratios shown in Table 13. Mixing was carried out for 10 hours by use of a ball mill. Thereby, inks P1, P2 for forming a positive electrode active material layer (hereinafter, referred to as an “ink for forming a positive electrode active material layer”) were prepared.

TABLE 13
Composition (weight ratio) of Inks for Forming
Positive Electrode Active Material Layer

| | | Ink for forming positive electrode | |
|---|---|---|---|
| | | active material layer | |
| | | P1 | P2 |
| Component | LiFePO_{4/}C | 132.5 | 132.5 |
| contained | SP-270 | 32.5 | 32.5 |
| | Solution N1 of | 132.5 | 162.5 |
| | precursor mixture | | |
| | L-11 | 6.63 | 6.63 |
| | AN | 100 | 100 |

“LiFePO₄/C” is a composite material of LiFePO₄ and C (carbon). “SP-270” is a flaked graphite powder manufactured by Nippon Graphite Industries, Co., Ltd. (Otsu-shi, Shiga, JAPAN). “L-11” is an ethylene oxide polymer (ALKOX (registered trademark) L-11) having a number average molecular weight of 110000 manufactured by Meisei Chemical Works, Ltd. (Kyoto-shi, Kyoto, JAPAN).

(Preparation of Negative Electrode-Side Laminates CNG1 to CNG12, CNT1 to CNT4)

A preparation example of the negative electrode-side laminate used in the method for producing a lithium-ion secondary battery of the embodiment 2 will be described.

Each of the inks for forming a negative electrode active material layer shown in Table 14 and Table 15 was applied onto a negative current collector (copper foil). A thickness of the applied ink was 30 μm in the case of the inks G1 to G4 for forming a negative electrode active material layer, and was 80 μm in the case of the inks T1 to T4 for forming a negative electrode active material layer. Subsequently, the applied ink for forming a negative electrode active material layer was dried with hot air. The hot air drying was carried out at 120° C. for 30 minutes. Moreover, subsequently, the resulting precursor layer was irradiated with electron beams. An accelerating voltage of the electron beam was 175 kV. An irradiation dose of the electron beam was 80 kGy. Thereby, a negative electrode active material layer was formed. The tackiness of the formed negative electrode active material layer was excellent.

TABLE 14
Raw Material, Degree of Adhesion and Adhesion of Negative Electrode-Side Laminate

| | Negative electrode-side laminate | | | | | | | | | | | | |
|---|---|---|---|---|---|---|---|---|---|---|---|---|---|
| | CNG1 | CNG 2 | CNG 3 | CNG 4 | CNT 1 | CNG 5 | CNG 6 | CNG 7* | CNG 8 | CNG 9 | CNG 10 | CNG 11 | CNG 12 |
| Ink for forming | G1 | G2 | G3 | G4 | T1 | G4 | G4 | G4 | G4 | G4 | G4 | G4 | G4 |
| negative electrode | | | | | | | | | | | | | |
| active material | | | | | | | | | | | | | |
| layer | | | | | | | | | | | | | |
| Solution of precursor | N1 | N1 | N1 | N1 | N1 | N2 | N3 | N4* | N5 | N6 | N1 | N2 | N3 |
| mixture | | | | | | | | | | | | | |
| Degree of adhesion | B | A | A | A | A | B | A | C | A | A | C | A | A |
| Adhesion | A | A | A | A | A | A | A | C | A | A | A | A | A |

TABLE 15
Raw Material, Degree of Adhesion and Adhesion
of Negative Electrode-Side Laminate

| Negative electrode-side laminate | CNT2 | CNT 3 | CNT 4 |
|---|---|---|---|
| Ink for forming negative | T2 | T3 | T4 |
| electrode active material layer | | | |
| Solution of precursor mixture | N1 | N1 | N1 |
| Degree of adhesion | A | A | B |
| Adhesion | A | A | A |

Next, each of the solution of a precursor mixture shown in Table 14 and Table 15 was applied onto a negative electrode active material layer. A thickness of the applied solution was 100 μm. Subsequently, the applied solution of a precursor mixture was dried with hot air. The hot air drying was carried out at 120° C. for 30 minutes. Moreover, subsequently, the resulting precursor layer was irradiated with electron beams. An accelerating voltage of the electron beam was 175 kV. An irradiation dose of the electron beam was 100 kGy. Thereby, a solid electrolyte layer was formed.

Next, the laminate of the negative current collector, the negative electrode active material layer and the solid electrolyte layer was punched out in an A6 size. Thereby, negative electrode-side laminates CNG1 to CNG12 and CNT1 to CNT4 were prepared.

A degree of adhesion between the negative electrode active material layer and the solid electrolyte layer and adhesion of the product formed on the current collecting surface of the negative current collector of the negative electrode-side laminates CNG1 to CNG12 and CNT1 to CNT4 were evaluated. The results of the evaluations are shown in Table 14 and Table 15. The level “C” of the degree of adhesion means that when the solid electrolyte layer is peeled, it peels off at an interface between the solid electrolyte layer and the negative electrode active material layer, and the level “A” of the degree of adhesion means that when the solid electrolyte layer is peeled, it does not peel off at an interface between the solid electrolyte layer and the negative electrode active material layer. The level “B” means that the level is an intermediate between “A” and “C”.

The tackiness of the negative electrode-side laminate CNG7 was defective and a unified laminate could not be attained. The tackiness of the negative electrode-side laminates other than the negative electrode-side laminate CNG7 was excellent.

(Preparation of Positive Electrode-Side Laminates PC1, PC2)

A preparation example of the positive electrode-side laminate used in the method for producing a lithium-ion secondary battery of the embodiment 2 will be described.

Each of the inks for forming a positive electrode active material layer shown in Table 16 was applied onto a positive current collector (aluminum foil). A thickness of the applied ink was 70 μm. Subsequently, the applied ink for forming a positive electrode active material layer was dried with hot air. The hot air drying was carried out at 120° C. for 60 minutes. Moreover, subsequently, the resulting precursor layer of a positive electrode active material layer was irradiated with electron beams. An accelerating voltage of the electron beam was 175 kV, and an irradiation dose of the electron beam was 80 kGy. Thereby, a positive electrode active material layer was formed.

TABLE 16
Raw Material and Adhesion of Positive Electrode-Side Laminate

| Positive electrode-side laminate | CP1 | CP 2 |
|---|---|---|
| Ink for forming positive | P1 | P2 |
| electrode active material layer | | |
| Adhesion | A | A |

Next, the laminate of the positive active material layer and the negative current collector was punched out in an A6 size. Thereby, positive electrode-side laminates PC1 and PC2 were prepared.

Adhesion of the product formed on the current collecting surfaces of the positive current collectors of the positive electrode-side laminates PC1 and PC2 was evaluated. The results of the evaluations are shown in Table 16.

(Preparation of Batteries C1 to C16)

Lithium-ion secondary batteries (hereinafter, referred to as just a “battery”) C1 to C16 were prepared according to the method for producing a lithium-ion secondary battery in the embodiment 2. A negative electrode-side laminate and a positive electrode-side laminate bonded to each other in each battery are shown in Table 17 and Table 18.

TABLE 17
Battery Performance

| | Negative | Positive | Open circuit | Discharge | |
|---|---|---|---|---|---|
| | electrode- | electrode- | voltage after | capacity of | Battery |
| | side | side | charging | 5 cycles | resistance |
| Battery | laminate | laminate | (V) | (mAh) | (Ω) |
| C1 | CNG1 | PC1 | 3.38 | 40 | 1.5 |
| C2 | CNG2 | PC1 | 3.37 | 55 | 0.9 |
| C3 | CNG3 | PC1 | 3.38 | 40 | 0.7 |
| C4 | CNG4 | PC1 | 3.38 | 43 | 1.3 |
| C5 | CNG5 | PC1 | 3.38 | 46 | 1.5 |
| C6 | CNG6 | PC1 | 3.37 | 45 | 1.2 |
| C7* | CNG7* | PC1 | — | — | — |
| C8 | CNG8 | PC1 | 3.38 | 49 | 0.8 |
| C9 | CNG9 | PC1 | 3.37 | 41 | 1.2 |
| C10 | CNG10 | PC2 | 3.38 | 39 | 0.8 |
| C11 | CNG11 | PC2 | 3.38 | 56 | 0.8 |
| C12 | CNG12 | PC2 | 3.38 | 44 | 0.6 |
| C13 | CNT 1 | PC2 | 1.98 | 43 | 0.5 |

TABLE 18
Battery Performance

| | Negative | Positive | Open circuit | Discharge | |
|---|---|---|---|---|---|
| | electrode- | electrode- | voltage after | capacity of | Battery |
| | side | side | charging | 5 cycles | resistance |
| Battery | laminate | laminate | (V) | (mAh) | (Ω) |
| C14 | CNT2 | PC2 | 1.98 | 43 | 0.5 |
| C15 | CNT3 | PC2 | 1.98 | 50 | 0.9 |
| C16 | CNT4 | PC2 | 1.98 | 43 | 1.1 |

The negative electrode-side laminate and the positive electrode-side laminate were vacuum-dried prior to bonding of the negative electrode-side laminate and the positive electrode-side laminate. The vacuum drying was performed at 130° C. over 8 hours. Bonding of the negative electrode-side laminate and the positive electrode-side laminate was carried out by pressure bonding after stacking the negative electrode-side laminate and the positive electrode-side laminate on top of each other. A bonded body of the negative electrode-side laminate and the positive electrode-side laminate was vacuum sealed with a three-layered laminate film which is a lamination of three layers of a plastic layer/an aluminum layer/a plastic layer.

In order to evaluate the batteries C1 to C16, charging and discharging of five cycles of the batteries C1 to C16 were carried out in an environment of 25° C. In the charging and discharging of each cycle, discharging was carried out after charging. A charging current was 5 mA. An end voltage of charging was 3.8 V for the batteries C1 to C12 and 2.4 V for batteries C13 to C16. A discharging current was 3 mA. An end voltage of discharging was 2.5 V for the batteries C1 to C12 and 1.5 V for batteries C13 to C16. A down time of one hour was provided between the charging and the discharging. The results are shown in Table 17 and Table 18.

“An open circuit voltage after charging” refers to an open circuit voltage after a lapse of down time of one hour after charging of the first cycle. In addition, a battery C7 was hard to prepare and was not evaluated.

(Preparation of Battery C17)

A battery C17 was prepared according to the method for producing a lithium-ion secondary battery in the embodiment 4.

The ink T1 for forming a negative electrode active material layer was applied onto a negative current collector (copper foil). A thickness of the applied ink was 80 μm. Subsequently, the applied ink for forming a negative electrode active material layer was dried with hot air. The hot air drying was carried out at 120° C. for 30 minutes. Moreover, subsequently, the resulting precursor layer was irradiated with electron beams. An accelerating voltage of the electron beam was 175 kV. An irradiation dose of the electron beam was 80 kGy. Thereby, a negative electrode active material layer was formed.

Next, the laminate of the negative current collector and the negative electrode active material layer was punched out in an A6 size. Thereby, a negative electrode-side laminate was prepared.

Aside from the preparation of the negative electrode-side laminate, the ink P2 for forming a positive electrode active material layer was applied onto a positive current collector (aluminum foil). A thickness of the applied ink was 70 μm. Subsequently, the applied ink for forming a positive electrode active material layer was dried with hot air. The hot air drying was carried out at 120° C. for 60 minutes. Moreover, subsequently, the resulting precursor layer was irradiated with electron beams. An accelerating voltage of the electron beam was 175 kV, and an irradiation dose of the electron beam was 80 kGy. Thereby, a positive electrode active material layer was formed.

Next, the laminate of the positive electrode active material layer and the positive current collector was punched out in an A6 size. Thereby, a positive electrode-side laminate was prepared.

Aside from the preparation of the negative electrode-side laminate and the positive electrode-side laminate, a solution N1 of a precursor mixture was applied onto a sheet of polytetrafluoroethylene. A thickness of the applied solution was 100 μm. Subsequently, the applied solution of a precursor mixture was dried with hot air. The hot air drying was carried out at 120° C. for 30 minutes. Moreover, subsequently, the resulting precursor layer of a solid electrolyte layer was irradiated with electron beams. An accelerating voltage of the electron beam was 200 kV, and an irradiation dose of the electron beam was 80 kGy. Thereby, a solid electrolyte layer was formed.

Next, the laminate of the sheet of polytetrafluoroethylene and the solid electrolyte layer was punched out in an A6 size, and the solid electrolyte layer was peeled off from the sheet of polytetrafluoroethylene. The tackiness of the solid electrolyte layer was excellent.

The negative electrode-side laminate, the solid electrolyte layer and the positive electrode-side laminate were vacuum-dried prior to bonding of the negative electrode-side laminate, the solid electrolyte layer and the positive electrode-side laminate. The vacuum drying was performed at 130° C. for 8 hours. Bonding of the negative electrode-side laminate, the solid electrolyte layer and the positive electrode-side laminate was carried out by pressure bonding after stacking the negative electrode-side laminate, the solid electrolyte layer and the positive electrode-side laminate on top of each other. A bonded body of the negative electrode-side laminate, the solid electrolyte layer and the positive electrode-side laminate was vacuum sealed with a three-layered laminate film which is a lamination of three layers of a plastic layer/an aluminum layer/a plastic layer.

The battery C17 was evaluated in the same manner as in batteries C1 to C13, and consequently an open circuit voltage after charging was 1.98 V, a discharge capacity was 41 mAh, and electric resistance was 0.6Ω.

In addition, in case of preparing a battery in which the lithium-ion conducting solid electrolyte was changed to a lithium-ion conducting solid electrolyte prepared by dissolving a lithium salt in crystalline polyethylene oxide having a molecular weight of 600000, the battery was capable of charging and discharging at 60° C., but it was incapable of charging and discharging at 25° C., and it could not achieve the results of evaluation comparable with the above-mentioned results of evaluation.

(Preparation of Battery C18)

A battery C18 was prepared according to the method for producing a lithium-ion secondary battery in the embodiment 7.

First, the ink T3 for forming a negative electrode active material layer was applied onto one surface 7018a of a bipolar current collector 7018 (aluminum foil). A thickness of the applied ink was 80 μm. Subsequently, the applied ink for forming a negative electrode active material layer was dried with hot air. The hot air drying was carried out at 120° C. for 30 minutes. Moreover, subsequently, the resulting precursor layer was irradiated with electron beams. An accelerating voltage of the electron beam was 175 kV. An irradiation dose of the electron beam was 80 kGy. Thereby, a negative electrode-side active material layer 7006a of a bipolar electrode was formed.

Next, a solution N1 of a precursor mixture was applied onto the negative electrode active material layer 7006a. A thickness of the applied solution was 100 μm. Subsequently, the applied solution of a precursor mixture was dried with hot air. The hot air drying was carried out at 120° C. for 30 minutes. Moreover, subsequently, the resulting precursor layer was irradiated with electron beams. An accelerating voltage of the electron beam was 175 kV. An irradiation dose of the electron beam was 100 kGy. Thereby, a solid electrolyte layer 7008a was formed to form a negative electrode-side negative active material laminate of a bipolar electrode.

Next, the ink P1 for forming a positive electrode active material layer was applied onto the other surface 7018b of the bipolar current collector 7018. A thickness of the applied ink was 70 μm. Subsequently, the applied ink for forming a positive electrode active material layer was dried with hot air. The hot air drying was carried out at 120° C. for 60 minutes. Moreover, subsequently, the resulting precursor layer of the positive electrode active material was irradiated with electron beams. An accelerating voltage of the electron beam was 175 kV, and an irradiation dose of the electron beam was 80 kGy. Thereby, a positive electrode-side active material layer 7010b of a bipolar electrode was formed. A bipolar electrode positive electrode-negative electrode laminate was prepared through these processes.

Next, the bipolar electrode positive electrode-negative electrode laminate was punched out in an A6 size. Thereby, a bipolar electrode laminate 7034 was prepared.

Adhesion between layers composing the bipolar electrode laminate 7034 was evaluated, and consequently, the adhesion between the solid electrolyte layer 7008a and the negative electrode active material layer 7006a, the adhesion between the bipolar current collector 7018 and the negative electrode active material layer 7006a, and the adhesion between the bipolar current collector 7018 and the positive electrode active material layer 7010b were all excellent.

Next, the ink T2 for forming a negative electrode active material was applied onto a negative current collector (copper foil) 7004. A thickness of the applied ink was 80 μm. Subsequently, the applied ink for forming a negative electrode active material was dried with hot air. The hot air drying was carried out at 120° C. for 30 minutes. Moreover, subsequently, the resulting precursor layer was irradiated with electron beams. An accelerating voltage of the electron beam was 175 kV. An irradiation dose of the electron beam was 80 kGy. Thereby, a negative electrode-side active material layer 7006b of a bipolar electrode was formed.

Moreover, a solution N1 of a precursor mixture was applied onto the negative electrode-side active material layer 7006b. A thickness of the applied solution was 100 μm. Subsequently, the applied solution of a precursor mixture was dried with hot air. The hot air drying was carried out at 120° C. for 30 minutes. Moreover, subsequently, the resulting precursor layer was irradiated with electron beams. An accelerating voltage of the electron beam was 175 kV. An irradiation dose of the electron beam was 100 kGy. Thereby, a solid electrolyte layer 7008b was formed to obtain a negative electrode active material laminate.

Next, the ink P1 for forming a positive electrode active material layer was applied onto a current collecting surface of a positive current collector (aluminum foil) 7012. A thickness of the applied ink was 70 μm. Subsequently, the applied ink for forming a positive electrode active material layer was dried with hot air. The hot air drying was carried out at 120° C. for 60 minutes. Moreover, subsequently, the resulting precursor layer of the positive electrode active material was irradiated with electron beams. An accelerating voltage of the electron beam was 175 kV, and an irradiation dose of the electron beam was 80 kGy. Thereby, a positive electrode active material layer 5010a was formed to obtain a positive electrode active material laminate.

Next, the negative electrode active material laminate and the positive electrode active material laminate were punched out in an A6 size. Thereby, a negative electrode laminate and a positive electrode laminate were prepared.

The negative electrode laminate, the bipolar electrode laminate and the positive electrode laminate were vacuum-dried prior to bonding of the negative electrode laminate, the bipolar electrode laminate and the positive electrode laminate. The vacuum drying was performed at 130° C. for 8 hours. Bonding of the negative electrode laminate, the bipolar electrode laminate and the positive electrode laminate was carried out in such a way that the surface of the positive electrode-side laminate in the bipolar electrode laminate is opposed to the surface of the electrolyte layer in the negative electrode laminate. Next, these laminates were stacked in such a way that the surface of the positive electrode laminate is opposed to the surface of the electrolyte layer of the negative electrode-side laminate in the bipolar electrode. Then, a bonded body of a bipolar battery was prepared by pressure bonding of the stacked negative electrode laminate, bipolar electrode laminate and positive electrode laminate. The bonded body of a bipolar battery was vacuum sealed with a three-layered laminate film which is a lamination of three layers of a plastic layer/an aluminum layer/a plastic layer to prepare a bipolar type polymer-lithium secondary battery C18.

The battery 17 was evaluated in the same manner as in batteries C1 to C15, and consequently an open circuit voltage after charging was 3.96 V, a discharge capacity was 40 mAh, and electric resistance was 1.30.

The present invention has been described in detail, but the above descriptions are illustrative and not restrictive in all aspects. Therefore, it is understood that various modifications and variations can be devised without departing from the scope of the invention

1. A solid electrolyte composition, comprising:
a hyperbranched polymer having a branched molecular chain comprising a polyalkylene oxide chain and a first crosslinking group;
a crosslinkable ethylene oxide multicomponent copolymer having a weight average molecular weight of 50000 to 300000 which is a multicomponent copolymer comprising in polymerized form two or more monomers comprising ethylene oxide and a glycidyl ether having a second crosslinking group to react with said first crosslinking group;
a non-reactive polyalkylene glycol having molecular chains comprising an oligoalkylene glycol chain, in which all terminals of the molecular chains are blocked with a non-reactive terminal group; and
a lithium salt.

2. The solid electrolyte composition according to claim 1, wherein said hyperbranched polymer comprises a constituent unit represented by formula (01): 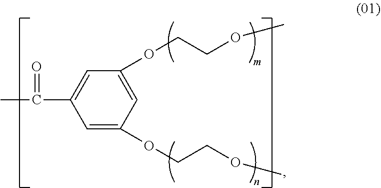
such that all of or a part of terminal groups is said first crosslinking group.

3. The solid electrolyte composition according to claim 1, wherein said crosslinkable ethylene oxide multicomponent copolymer is a binary copolymer comprising constituent units represented by formulas (02) and (03): 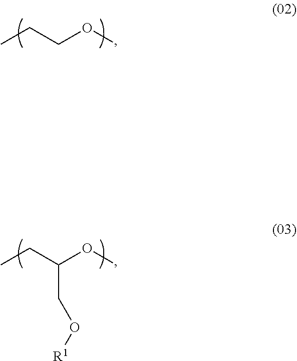
arranged irregularly, and R¹ in formula (03) is an allyl group.

4. The solid electrolyte composition according to claim 1, wherein said non-reactive polyalkylene glycol is an oligomer represented by formula (04):

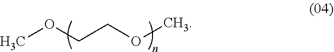

5. The solid electrolyte composition according to claim 1, further comprising:
a noncrosslinkable ethylene oxide homopolymer having a weight average molecular weight of 50000 to 300000 and not comprising a group to react with said first crosslinking group.

6. The solid electrolyte composition according to claim 5, wherein said noncrosslinkable ethylene oxide homopolymer is a homopolymer comprising a constituent unit represented by formula (05):

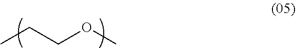

7. The solid electrolyte composition according to claim 1, further comprising:
a noncrosslinkable ethylene oxide multicomponent copolymer having a weight average molecular weight of 50000 to 300000, which is a multicomponent copolymer comprising in polymerized form two or more monomers comprising ethylene oxide and an alkylene oxide other than ethylene oxide, and not comprising a group to react with said first crosslinking group.

8. The solid electrolyte composition according to claim 7, wherein said noncrosslinkable ethylene oxide multicomponent copolymer is a binary copolymer comprising constituent units represented by formulas (06) and (07): 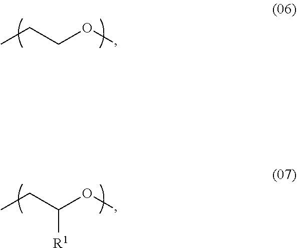
arranged irregularly, and R¹ in formula (07) is a methyl group.

9. A solid electrolyte, comprising:
a co-crosslinked product produced by chemically co-crosslinking a hyperbranched polymer comprising a branched molecular chain comprising a polyalkylene oxide chain and a first crosslinking group with a crosslinkable ethylene oxide multicomponent copolymer having a weight average molecular weight of 50000 to 300000 which is a multicomponent copolymer comprising in polymerized form two or more monomers comprising ethylene oxide and a glycidyl ether having a second crosslinking group to react with said first crosslinking group;
a non-reactive polyalkylene glycol held on said co-crosslinked product and comprising molecular chains comprising an oligoalkylene glycol chain, in which all terminals of the molecular chains are blocked with a non-reactive terminal group; and
a lithium salt dissolved in a matrix comprising said co-crosslinked product and said non-reactive polyalkylene glycol.

10. The solid electrolyte according to claim 9, further comprising:
a noncrosslinkable ethylene oxide homopolymer which is physically crosslinked with said co-crosslinked product, has a weight average molecular weight of 50000 to 300000, and does not comprise a group to react with said first crosslinking group.

11. The solid electrolyte according to claim 9, further comprising:
a noncrosslinkable ethylene oxide multicomponent copolymer which is physically crosslinked with said co-crosslinked product, has a weight average molecular weight of 50000 to 300000, is a multicomponent copolymer comprising two or more monomers comprising ethylene oxide and an alkylene oxide other than ethylene oxide, and does not comprise a group to react with said first crosslinking group.

12. A lithium-ion secondary battery comprising:
a negative electrode active material layer;
a positive electrode active material layer; and
a solid electrolyte layer interposed between said negative electrode active material layer and said positive electrode active material layer,
wherein:
said negative electrode active material layer comprises a lithium-ion conducting first solid electrolyte, and a negative electrode active material and a first conduction aid which are dispersed in said first solid electrolyte;
said positive electrode active material layer comprises a lithium-ion conducting second solid electrolyte, and a positive electrode active material and a second conduction aid which are dispersed in said second solid electrolyte;
said solid electrolyte layer comprises a lithium-ion conducting third solid electrolyte;
said first solid electrolyte, said second solid electrolyte and said third solid electrolyte comprise
a co-crosslinked product produced by chemically co-crosslinking a hyperbranched polymer with a crosslinkable ethylene oxide multicomponent copolymer,
a non-reactive polyalkylene glycol held on said co-crosslinked product and having molecular chains comprising an oligoalkylene glycol chain, in which all terminals of the molecular chains are blocked with a non-reactive terminal group, and
a lithium salt dissolved in a matrix comprising said co-crosslinked product and said non-reactive polyalkylene glycol,
such that
said hyperbranched polymer comprises a branched molecular chain comprising a polyalkylene oxide chain and a first crosslinking group, and
said crosslinkable ethylene oxide multicomponent copolymer has a weight average molecular weight of 50000 to 300000 and is a multicomponent copolymer comprising two or more monomers comprising ethylene oxide and a glycidyl ether having a second crosslinking group to react with said first crosslinking group.

13. The lithium-ion secondary battery according to claim 12, wherein:
particles of said negative electrode active material and particles of said first conduction aid are brought into contact with each other to link together to form a path of electron conduction within said negative electrode active material layer; and
particles of said positive electrode active material and particles of said second conduction aid are brought into contact with each other to link together to form a path of electron conduction within said positive electrode active material layer.

14. The lithium-ion secondary battery according to claim 12, wherein said first solid electrolyte, said second solid electrolyte and said third solid electrolyte respectively further comprise:
a noncrosslinkable ethylene oxide homopolymer which is physically crosslinked with said co-crosslinked product, has a weight average molecular weight of 50000 to 300000, and does not comprise a group to react with said first crosslinking group.

15. The lithium-ion secondary battery according to claim 12, wherein said first solid electrolyte, said second solid electrolyte and said third solid electrolyte respectively further comprise:
a noncrosslinkable ethylene oxide multicomponent copolymer which is physically crosslinked with said co-crosslinked product, has a weight average molecular weight of 50000 to 300000, is a multicomponent copolymer comprising two or more monomers comprising ethylene oxide and an alkylene oxide other than ethylene oxide, and does not comprise a group to react with said first crosslinking group.

16. A method for producing a lithium-ion secondary battery, the method comprising:
a) forming a first layer in which a negative electrode active material and a first conduction aid are dispersed in a first precursor mixture to become a lithium-ion conducting solid electrolyte by irradiation of electron beams;
b) forming a second layer in which a positive electrode active material and a second conduction aid are dispersed in a second precursor mixture to become a lithium-ion conducting solid electrolyte by irradiation of electron beams;
c) forming a third layer comprising a third precursor mixture to become a lithium-ion conducting solid electrolyte by irradiation of electron beams;
d) forming a bonded body in which said third layer is interposed between said first layer and said second layer; and
e) irradiating said first layer, said second layer and said third layer together or separately with electron beams,
wherein:
said first precursor mixture, said second precursor mixture and said third precursor mixture comprise:
a hyperbranched polymer comprising having a branched molecular chain comprising a polyalkylene oxide chain and a first crosslinking group;
a crosslinkable ethylene oxide multicomponent copolymer which has a weight average molecular weight of 50000 to 300000 and is a multicomponent copolymer comprising two or more monomers comprising ethylene oxide and a glycidyl ether comprising a second crosslinking group to react with said first crosslinking group;
a non-reactive polyalkylene glycol comprising molecular chains comprising an oligoalkylene glycol chain, in which all terminals of the molecular chains are blocked with a non-reactive terminal group; and
a lithium salt.
